(19) United States
(12) Patent Application Publication
(10) Pub. No.: US 2014/0170921 A1
(43) Pub. Date: Jun. 19, 2014

(54) HIGH TEMPERATURE RESISTANT INORGANIC FIBER

(71) Applicant: UNIFRAX I LLC, Niagara Falls, NY (US)

(72) Inventors: Bruce K. Zoitos, Williamsville, NY (US); Michael J. Andrejack, Amherst, NY (US)

(73) Assignee: UNIFRAX I LLC, Niagara Falls, NY (US)

(21) Appl. No.: 13/720,178

(22) Filed: Dec. 19, 2012

(51) Int. Cl. C03C 13/00; C03C 25/42

(52) U.S. Cl. CPC C03C 13/00; C03C 25/42
USPC 442/320; 252/62; 501/35; 428/389; 65/443

(57) ABSTRACT

Provided is an inorganic fiber containing silica and magnesia as the major fiber components which further includes a phosphate additive to the melt of fiber ingredients, or as a coating on the surfaces of the fiber, or both. The inorganic fiber exhibits improved thermal performance properties and is non-durable in physiological fluids. Also provided are methods of preparing the inorganic fiber and of thermally insulating articles using thermal insulation prepared from a plurality of the inorganic fibers.

### CROSS REFERENCE TO RELATED APPLICATIONS

This application claims the benefit of the filing date under 35 U.S.C. §119(e) of U.S. Provisional Application For Patent Ser. No. 61/577,320 filed Dec. 19, 2011, which is hereby incorporated by reference.

### TECHNICAL FIELD

A high temperature resistant inorganic fiber that is useful as a thermal, electrical, or acoustical insulating material, and which has a use temperature of 1400° C. and greater is provided. The high temperature resistant inorganic fiber is easily manufacturable, exhibits low shrinkage after prolonged exposure to the use temperature, retains good mechanical strength after exposure to the use temperature, and is soluble in physiological fluids.

### BACKGROUND

The insulation material industry has determined that it is desirable to utilize fibers in thermal, electrical and acoustical insulating applications, which are not durable in physiological fluids, that is, fiber compositions which exhibit a low biopersistence or a high solubility in physiological fluids. While candidate materials have been proposed, the use temperature limit of these materials have not been high enough to accommodate many of the applications to which high temperature resistant fibers, including synthetic vitreous fibers and ceramic fibers, are applied. Many other compositions within the synthetic vitreous fiber family of materials have been proposed which are non-durable or decomposable in a physiological medium.

The high temperature resistant fibers should also exhibit minimal linear shrinkage at expected exposure temperatures, and after prolonged or continuous exposure to the expected use temperatures, in order to provide effective thermal protection to the article being insulated.

In addition to temperature resistance as expressed by shrinkage characteristics that are important in fibers that are used in insulation, it is also required that the fibers have mechanical strength characteristics during and following exposure to the use or service temperature, that will permit the fiber to maintain its structural integrity and insulating characteristics in use.

One characteristic of the mechanical integrity of a fiber is its after service friability. The more friable a fiber, that is, the more easily it is crushed or crumbled to a powder, the less mechanical integrity it possesses. In general, inorganic fibers that exhibit both high temperature resistance and non-durability in physiological fluids also exhibit a high degree of after service friability. This results in the fiber lacking the strength or mechanical integrity after exposure to the service temperature to be able to provide the necessary structure to accomplish its insulating purpose. Other measures of mechanical integrity of fibers include compression strength and compression recovery.

Thus, it is desirable to produce an improved inorganic fiber composition that is readily manufacturable from a fiberizable melt of desired ingredients, which exhibits low shrinkage during and after exposure to service temperatures of 1400° C. or greater, which exhibits low brittleness after exposure to the expected use temperatures, and which maintains mechanical integrity after exposure to use temperatures of 1400° C. or greater.

### DETAILED DESCRIPTION

Provided is a low shrinkage, high temperature resistant inorganic fiber having a use temperature of 1260° C. or greater, which maintains mechanical integrity after exposure to the use temperature, and which is non-durable in physiological fluids

According to illustrative embodiments, provided is a low shrinkage, high temperature resistant inorganic fiber having a use temperature of 1400° C. or greater, which maintains mechanical integrity after exposure to the use temperature, and which is non-durable in physiological fluids. The inorganic fiber comprises the fiberization product of a melt comprising about 65 to about 86 weight percent silica and about 14 to about 35 weight percent magnesia, and an addition of a phosphorous containing compound. The phosphorous containing compound may be incorporated throughout the fiber, or as a coating on at least a portion of the fiber, or both.

Also provided are methods for preparing a low shrinkage, high temperature resistant inorganic fiber having a use temperature of 1260° C., or greater, which maintains mechanical integrity up to the use temperature and which is non-durable in physiological fluids.

According to illustrative embodiments, the method for preparing a low shrinkage, high temperature resistant inorganic fiber having a use temperature of 1400° C., or greater, which maintains mechanical integrity up to the use temperature and which is non-durable in physiological fluids. The method comprises forming a melt with ingredients comprising greater than about 65 to about 86 weight percent silica, about 14 to about 35 weight percent magnesia, and a phosphorous containing compound, producing fibers from the melt.

According to other illustrative embodiments, the method for preparing a low shrinkage, high temperature resistant inorganic fiber having a use temperature of 1400° C., or greater, which maintains mechanical integrity up to the use temperature and which is non-durable in physiological fluids. The method comprises forming a melt with ingredients comprising greater than about 65 to about 86 weight percent silica and about 14 to about 35 weight percent magnesia and producing fibers from the melt. At least a portion of the resulting fibers are coated with a phosphorous containing compound. The inorganic fibers may be coated with the phosphorous containing compound at the point of fiberization or after fiberization.

Also provided is a method for preparing a low shrinkage, high temperature resistant inorganic fiber having a use temperature of 1400° C., or greater, which maintains mechanical integrity up to the use temperature and which is non-durable in physiological fluids. The method comprises forming a melt with ingredients comprising greater than about 65 to about 86 weight percent silica, about 14 to about 35 weight percent magnesia, and a phosphorous containing compound, producing fibers from the melt, and coating at least a portion of the resulting fibers with a phosphorous containing compound. The inorganic fibers may be coated with the phosphorous containing compound at the point of fiberization or after fiberization. According to this method, the fibers include a phosphorous compound within the fiber and also on at least a portion of the exterior surface of the fiber.

According to an illustrative embodiment, the method for preparing a low shrinkage, high temperature resistant inorganic fiber comprises forming a melt with ingredients comprising greater than 65 to about 86 weight percent silica and about 14 to about 35 weight percent magnesia, producing fibers from the melt, and; coating at least a portion of the resulting fibers at the point of fiberization or after fiberization with a phosphorous containing compound.

Also provided is a method of insulating an article with fibrous insulation prepared from the inorganic fibers. The method includes disposing on, in, near or around the article, a thermal insulation material having a use temperature of 1260° C., or greater, which maintains mechanical integrity up to the use temperature and which is non-durable in physiological fluids, the insulation material comprising the fiberization product of a melt of ingredients comprising about 65 to about 86 weight percent silica, about 14 to about 35 weight percent magnesia, and a phosphorous containing compound.

Also provided is a method of insulating an article with fibrous insulation prepared from the inorganic fibers. The method includes disposing on, in, near or around the article, a thermal insulation material having a use temperature of 1400° C., or greater, which maintains mechanical integrity up to the use temperature and which is non-durable in physiological fluids, the insulation material comprising the fiberization product of a melt of ingredients comprising about 65 to about 86 weight percent silica, about 14 to about 35 weight percent magnesia, and a phosphorous containing compound.

According to alternative embodiments, the method of insulating an article includes disposing on, in, near or around the article, a thermal insulation material having a use temperature up to at least 1260° C., or greater, which maintains mechanical integrity up to the use temperature and which is non-durable in physiological fluids, said insulation material comprising the fiberization product of a melt of ingredients comprising greater than 71.25 to about 86 weight percent silica and about 14 to about 35 weight percent magnesia, and a coating of a phosphorous containing compound.

According to alternative embodiments, the method of insulating an article includes disposing on, in, near or around the article, a thermal insulation material having a use temperature up to at least 1400° C., or greater, which maintains mechanical integrity up to the use temperature and which is non-durable in physiological fluids, said insulation material comprising the fiberization product of a melt of ingredients comprising greater than 71.25 to about 86 weight percent silica and about 14 to about 35 weight percent magnesia, and a coating of a phosphorous containing compound.

According to alternative embodiments, the method of insulating an article includes disposing on, in, near or around the article, a thermal insulation material having a use temperature up to at least 1400° C., or greater, which maintains mechanical integrity up to the use temperature and which is non-durable in physiological fluids, said insulation material comprising the fiberization product of a melt with ingredients comprising greater than about 65 to about 86 weight percent silica, about 14 to about 35 weight percent magnesia, and a phosphorous containing compound, producing fibers from the melt, and coating at least a portion of the resulting fibers with a phosphorous containing compound.

Also provided is an inorganic fiber containing article, as described above, comprising at least one of bulk fiber, blankets, needled blankets, papers, felts, cast shapes, vacuum cast forms, or compositions.

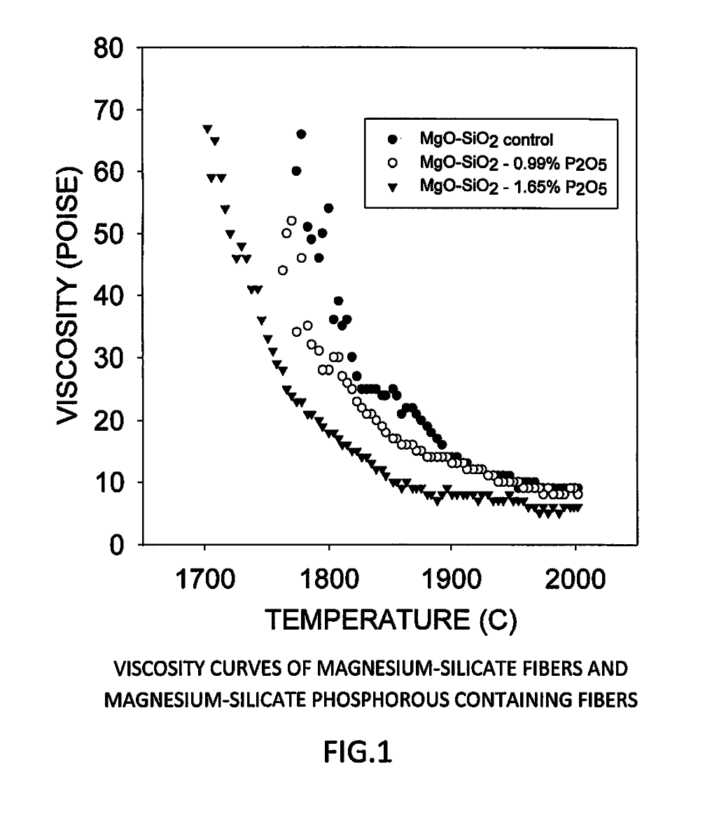

FIG. 1 is a viscosity vs. temperature curve of a melt chemistry for a commercially available magnesium-silicate fiber and magnesium-silicate fiber which includes a phosphorous containing compound.

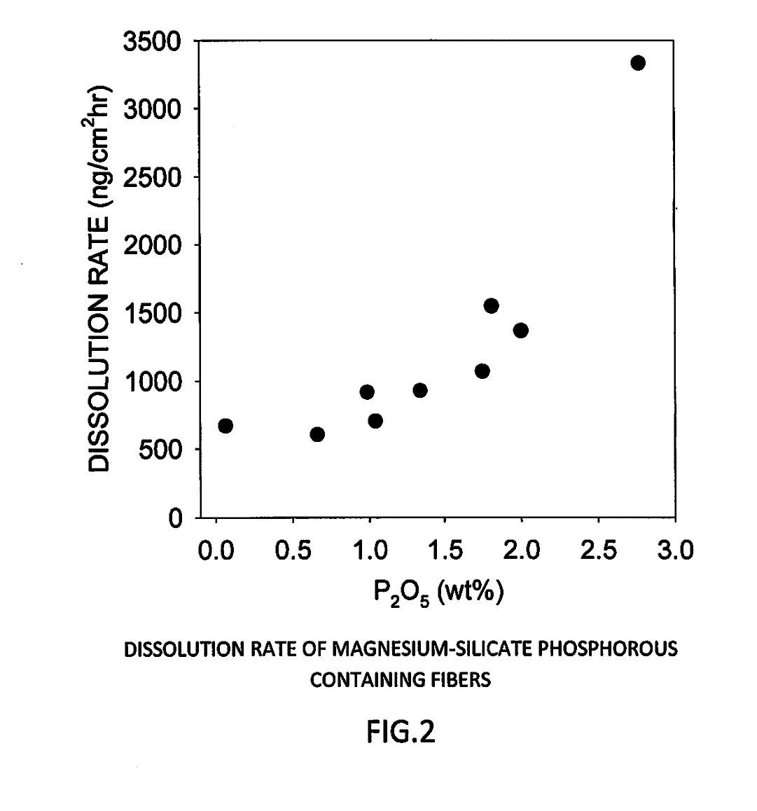

FIG. 2 is a graph showing the dissolution rate of magnesium-silicate fibers which include varying amounts of a phosphorous containing compound.

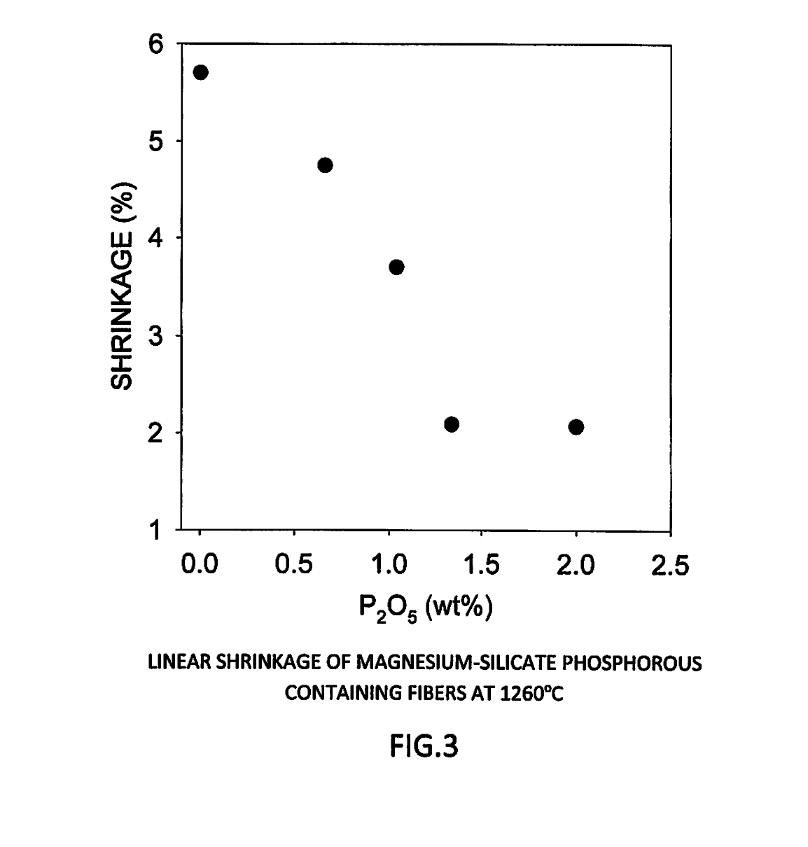

FIG. 3 is a graph which shows the linear shrinkage at 1260° C. of magnesium-silicate fibers which include varying amounts of a phosphorous containing compound.

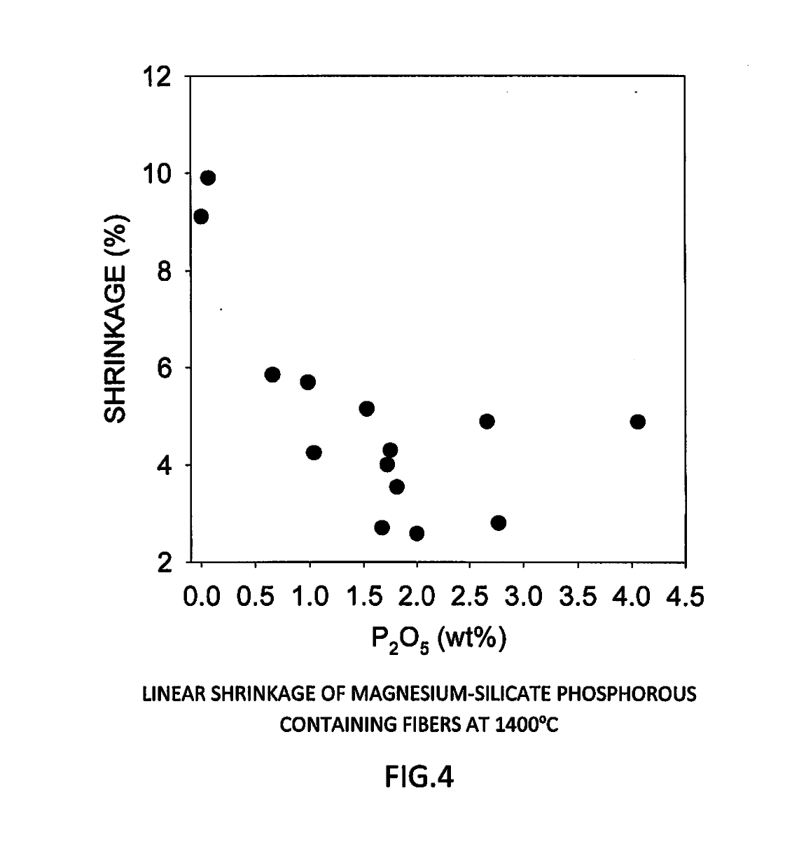

FIG. 4 is a graph which shows the linear shrinkage at 1400° C. of magnesium-silicate fibers which include varying amounts of a phosphorous containing compound.

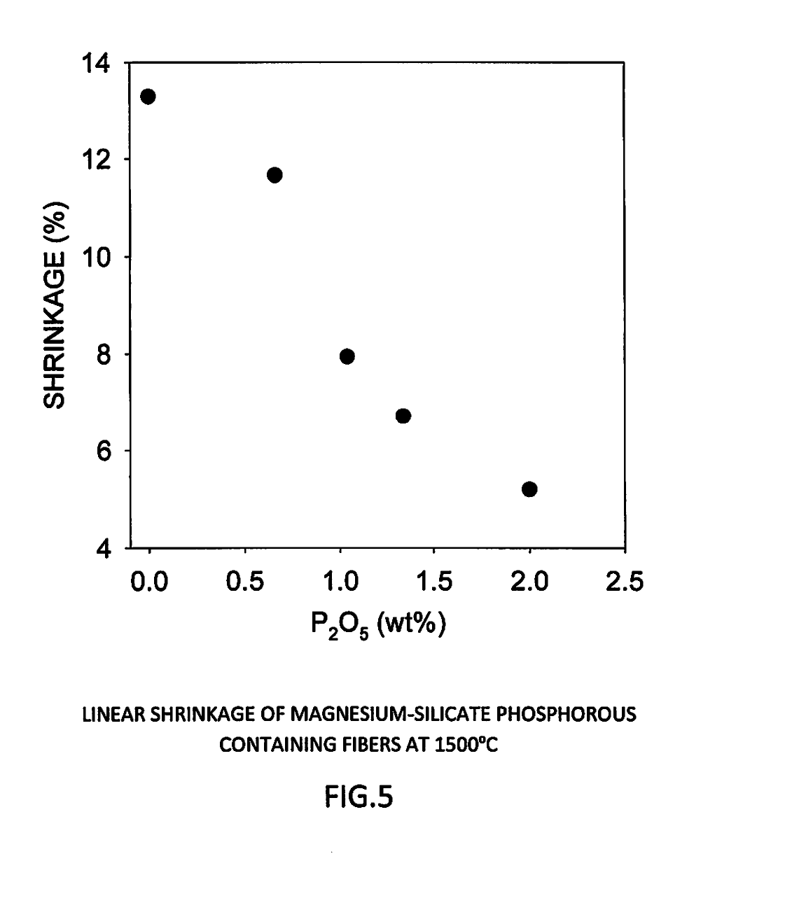

FIG. 5 is a graph which shows the linear shrinkage at 1500° C. of magnesium-silicate fibers which include varying amounts of a phosphorous containing compound.

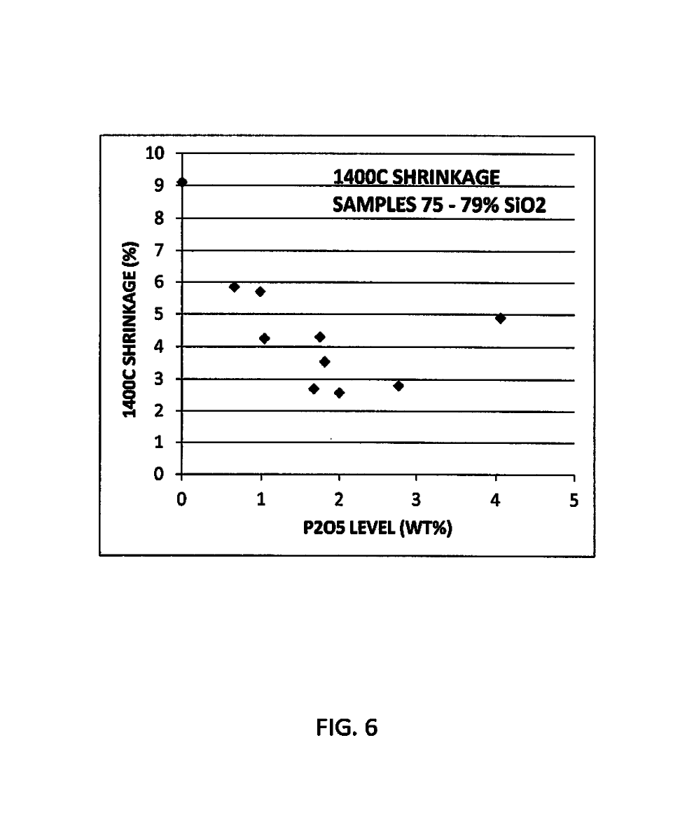

FIG. 6 is a graph which shows linear shrinkage at 1400° C. of magnesium silicate fibers prepared from about 75 to about 79 weight percent silica and which include varying ranges of a phosphorous containing compound.

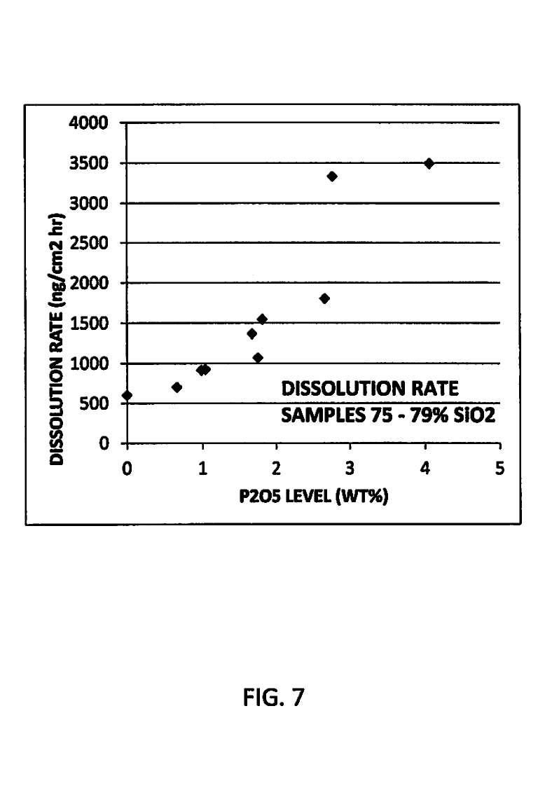

FIG. 7 is a graph showing the dissolution rate of magnesium silicate fibers prepared from about 75 to about 79 weight percent silica and which include varying amounts of a phosphorous containing compound.

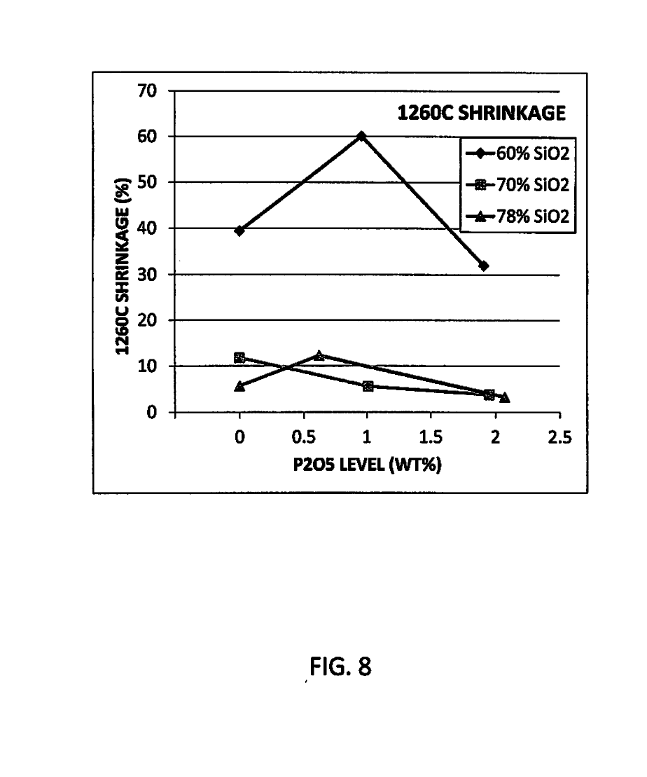

FIG. 8 is a graph which shows linear shrinkage at 1260° C. of magnesium silicate fibers prepared having different target levels of silica and which include varying ranges of a phosphorous containing compound.

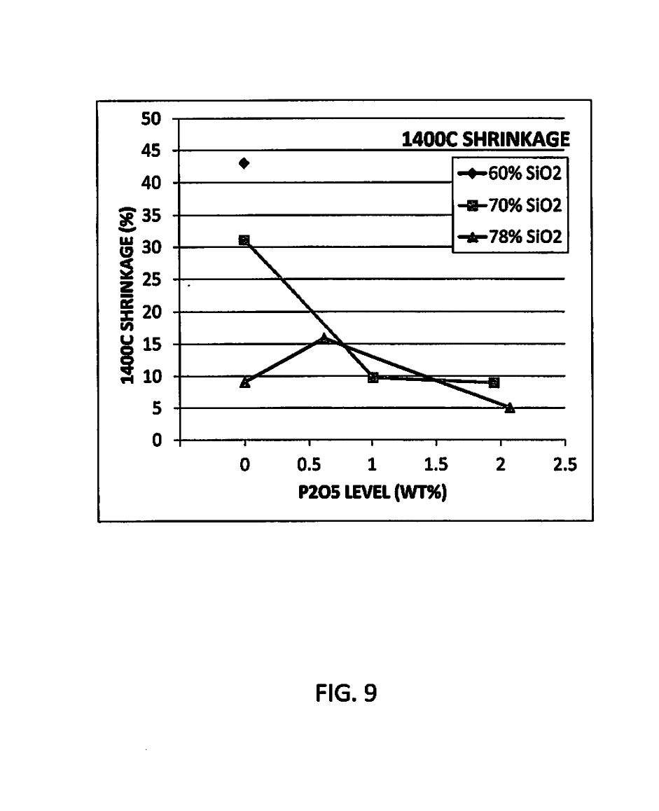

FIG. 9 is a graph which shows linear shrinkage at 1400° C. of magnesium silicate fibers prepared having different target levels of silica and which include varying ranges of a phosphorous containing compound.

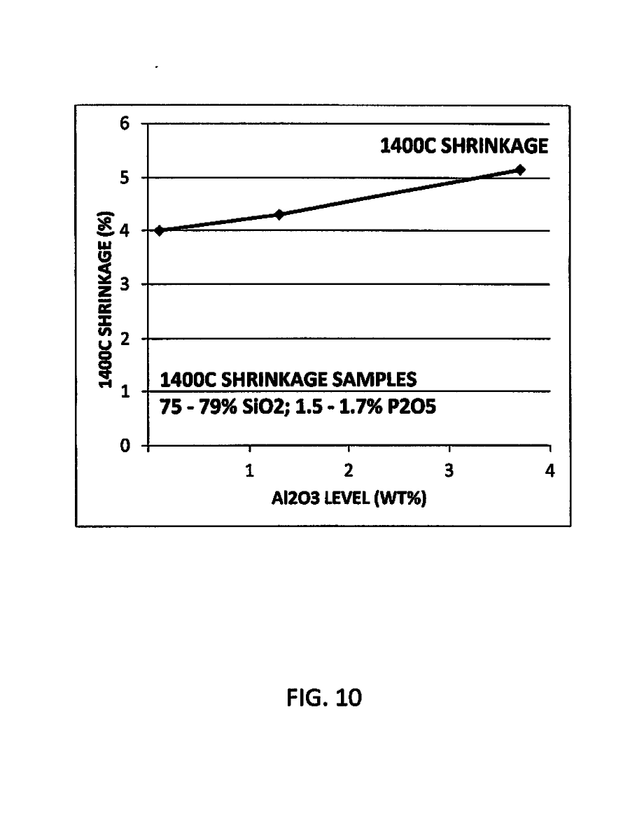

FIG. 10 is a graph which shows linear shrinkage at 1400° C. of high alumina-containing magnesium silicate fibers prepared from about 75 to about 79 weight percent silica and which include varying ranges of a phosphorous containing compound.

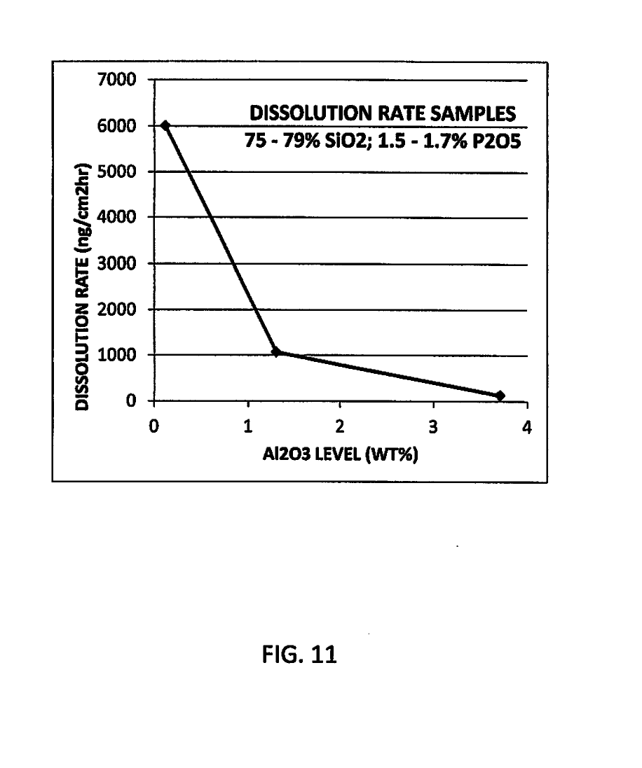

FIG. 11 is a graph showing the dissolution rate of high alumina-containing magnesium silicate fibers prepared from about 75 to about 79 weight percent silica and which include varying amounts of a phosphorous containing compound.

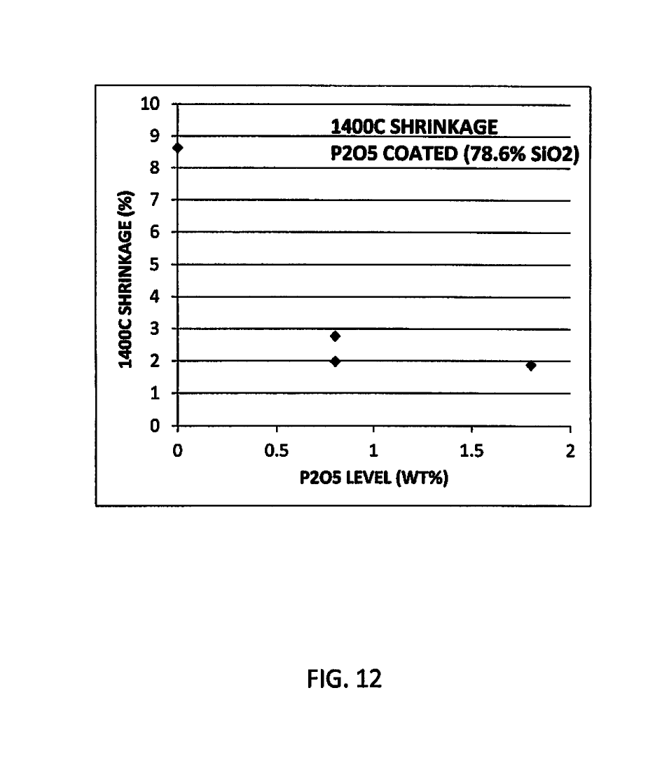

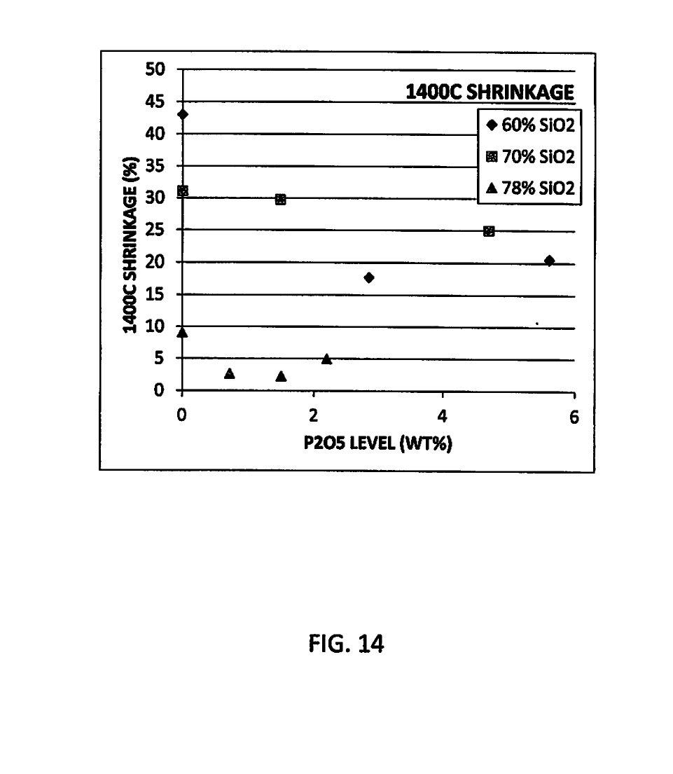

FIGS. 12 and 14 are graphs which show the linear shrinkage at 1400° C. of magnesium-silicate fibers which include varying amounts of a phosphorous containing compound as a coating on the exterior surfaces of the fiber.

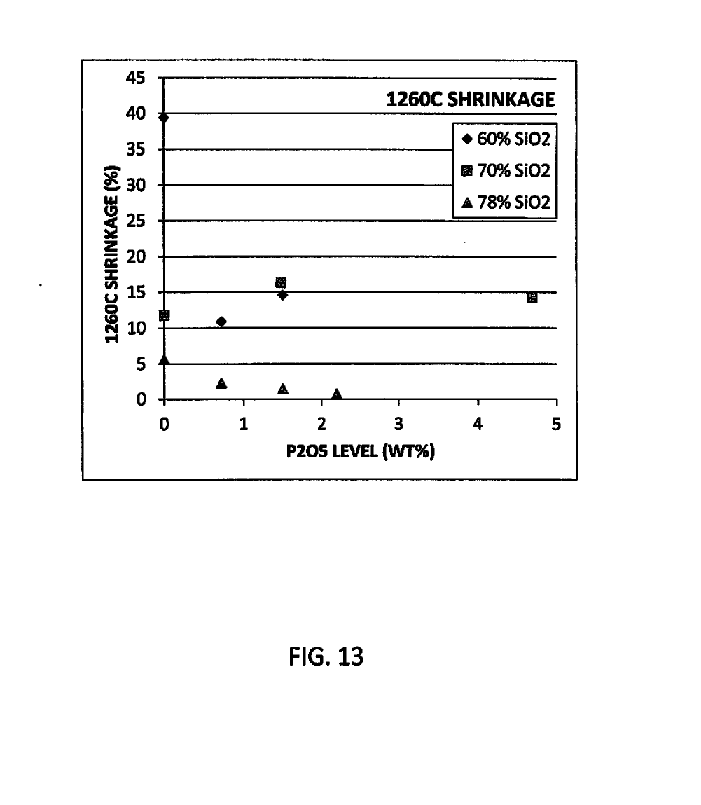

FIG. 13 is a graph which shows the linear shrinkage at 1260° C. of magnesium-silicate fibers which include varying amounts of a phosphorous containing compound as a coating on the exterior surfaces of the fiber.

An inorganic fiber that is useful as a thermal, electrical, and acoustical insulation material is provided. The vitreous inorganic fiber has a continuous service or use temperature of 1260° C. or greater. According to other embodiments, the vitreous inorganic fiber has a continuous service or use temperature of 1400° C. or greater.

In order for a glass composition to be a viable candidate for producing a satisfactory high temperature resistant fiber product, the fiber to be produced must be manufacturable, sufficiently soluble in physiological fluids, and capable of surviving high temperatures with minimal shrinkage and minimal loss of mechanical integrity during exposure to the high service temperatures.

The present inorganic fiber is non-durable in physiological fluids. By “non-durable” in physiological fluids, it is meant that the inorganic fiber at least partially dissolves in such fluids, such as simulated lung fluid, during in vitro tests. The inorganic vitreous fiber also exhibits a linear shrinkage, as determined by the test method described below, of less than about 3.5 percent in response to exposure to a use temperature of 1260° C. for 24 hours and less than 4.0 percent in response to exposure to a use temperature of 1400° C. for 24 hours.

Durability may be tested by measuring the rate at which mass is lost from the fiber (ng/cm²-hr) under conditions which simulate the temperature and chemical conditions found in the human lung. This test consists of exposing approximately 0.1 g of de-shotted fiber to 50 ml of simulated lung fluid (SLF) for 6 hours. The entire test system is maintained at 37° C., to simulate the temperature of the human body.

After the SLF has been exposed to the fiber, it is collected and analyzed for glass constituents using Inductively Coupled Plasma Spectroscopy. A “blank” SLF sample is also measured and used to correct for elements present in the SLF. Once this data has been obtained, it is possible to calculate the rate at which the fiber has lost mass over the time interval of the study. The fibers of the present invention are significantly less durable than normal refractory ceramic fiber in simulated lung fluid.

FIG. 2 is a graph which illustrates the fiber dissolution rate of various magnesium-silicate phosphorous containing fiber compositions. The fiber compositions of FIG. 2 generally comprise from about 75.4 to about 79.2 weight percent silica, from about 0.17 to about 0.4 weight percent calcia impurity, from about 17.1 to about 20.7 weight percent magnesia, from about 1.1 to about 1.7 weight percent alumina and varying amounts of a phosphorous containing compound (i.e., up to 3.0 weight percent). As is shown in FIG. 2, the rate of dissolution (ng/cm² hr) generally increases when the amount of phosphorous containing compound is increased within the magnesium-silicate fiber composition.

“Viscosity” refers to the ability of a glass melt to resist flow or shear stress. The viscosity-temperature relationship is critical in determining whether it is possible to fiberize a given glass composition. An optimum viscosity curve would have a low viscosity (5-50 poise) at the fiberization temperature and would gradually increase as the temperature decreased. If the melt is not sufficiently viscous (i.e. too thin) at the fiberization temperature, the result is a short, thin fiber, with a high proportion of unfiberized material (shot). If the melt is too viscous at the fiberization temperature, the resulting fiber will be extremely coarse (high diameter) and short.

Viscosity is dependent upon melt chemistry, which is also affected by elements or compounds that act as viscosity modifiers. Viscosity modifiers permit fibers to be blown or spun from the fiber melt. It is desireable, however, that such viscosity modifiers, either by type or amount, do not adversely impact the solubility, shrink resistance, or mechanical strength of the blown or spun fiber.

One approach to testing whether a fiber of a defined composition can be readily manufactured at an acceptable quality level is to determine whether the viscosity curve of the experimental chemistry matches that of a known product which can be easily fiberized. Viscosity-temperature profiles may be measured on a viscometer, capable of operating at elevated temperatures. In addition, an adequate viscosity profile may be inferred by routine experimentation, examining the quality of fiber (index, diameter, length) produced. The shape of the viscosity vs. temperature curve for a glass composition is representative of the ease with which a melt will fiberize and thus, of the quality of the resulting fiber (affecting, for example, the fiber's shot content, fiber diameter, and fiber length). Glasses generally have low viscosity at high temperatures. As temperature decreases, the viscosity increases. The value of the viscosity at a given temperature will vary as a function of the composition, as will the overall steepness of the viscosity vs. temperature curve. The viscosity curve of a magnesium-silicate phosphorous containing fiber has a viscosity that approximates the target viscosity curve of the FIG. 1 for the commercially available, spun magnesium-silicate fiber.

Linear shrinkage of an inorganic fiber is a good measure of a fiber's high temperature resistance or of its performance at a particular continuous service or use temperature. Fibers are tested for shrinkage by forming them into a mat and needle punching the mat together into a blanket of approximately 8 pounds per cubic foot density and a thickness of about 1 inch. Such pads are cut into 3 inch×5 inch pieces and platinum pins are inserted into the face of the material. The separation distance of these pins is then carefully measured and recorded. The pad is then placed into a furnace, ramped to temperature and held at the temperature for a fixed period of time. After heating, the pin separation is again measured to determine the linear shrinkage that pad has experienced.

In one such test, the length and width of this piece were carefully measured, and the pad was placed in a furnace and brought to a temperature of 1400° C. for 24, 168, or 672 hours. After cooling, the lateral dimensions were measured and the linear shrinkage was determined by comparing “before” and “after” measurements. If the fiber is available in blanket form, measurements may be made directly on the blanket without the need to form a pad.

Experimentation of the present magnesium-silicate phosphorous containing fibers disclosed herein has shown a linear shrinkage as low as 0.83% after exposure to 1260° C. for 24 hours and 3.5% or less after exposure to 1400° C. for 24 hours. Thus, the addition of a phosphorous containing compound, either as a direct additive to the melt chemistry or as a coating applied to the fiber at the point of fiberization or after fiberization, to a magnesium-silicate fiber improves the shrinkage performance of the inorganic fiber at temperatures of 1400° C.

FIGS. 3-5 are graphs which illustrate the linear shrinkage of various magnesium-silicate phosphorous containing fiber compositions at temperatures of 1260° C., 1400° C. and 1500° C. respectively. The fiber compositions of FIGS. 3-5 generally comprise from about 75.4 to about 79.2 weight percent silica, from about 0.17 to about 0.4 weight percent calcia impurity, from about 17.1 to about 20.7 weight percent magnesia, from about 1.1 to about 1.7 weight percent alumina and varying amounts of a phosphorous containing compound (i.e., up to about 2.5 weight percent and up to about 4.5 weight percent). As is shown in FIGS. 3-5, the amount of fiber shrinkage at 1260° C., 1400° C. and 1500° C. generally decreases with increasing amounts of a phosphorous containing compound.

Mechanical integrity is also an important property since the fiber must support its own weight in any application and must also be able to resist abrasion due to moving air or gas. Indications of fiber integrity and mechanical strength are provided by visual and tactile observations, as well as mechanical measurement of these properties of after-service temperature exposed fibers. The ability of the fiber to maintain its integrity after exposure to the use temperature may also be measured mechanically by testing for compression strength and compression recovery. These tests measure, respectively, how easily the pad may be deformed and the amount of resiliency (or compression recovery) the pad exhibits after a compression of 50%. Visual and tactile observations indicate that the present inorganic fiber remains intact and maintains its form after exposure to a use temperature of at least 1400° C.

The low shrinkage, high temperature resistant inorganic fiber comprises the fiberization product of a melt containing magnesia and silica as the primary constituents. The non-durable inorganic fibers are made by standard glass and ceramic fiber manufacturing methods. Raw materials, such as silica, any suitable source of magnesia such as enstatite, forsterite, magnesia, magnesite, calcined magnesite, magnesium zirconate, periclase, steatite, or talc, and, if zirconia is included in the fiber melt, any suitable source of zirconia such as baddeleyite, magnesium zirconate, zircon or zirconia, are introduced into a suitable furnace where they are melted and blown using a fiberization nozzle, or spun, either in a batch or a continuous mode.

The inorganic fiber comprising the fiberization product of magnesia and silica is referred to as a “magnesium-silicate” fiber. The low shrinkage, high temperature resistant inorganic fiber also comprises a phosphorous containing compound as part of the melt chemistry of the fiber composition or as a coating that is applied to the fiber at the point of fiberization or after fiberization. In alternative embodiments, the inorganic fiber may comprise a phosphorous containing compound as both part of its melt chemistry and as a coating which is applied to at least a portion of the exterior surface of the inorganic fiber.

According certain embodiments, the present inorganic fiber comprises the fiberization product of about 65 to about 86 weight percent silica, about 14 to about 35 weight percent magnesia, and greater than 0 to about 10 weight percent of a phosphorous containing compound. In alternative embodiments, the fiber comprises the fiberization product of about 65 to about 86 weight percent silica, about 14 to about 35 weight percent magnesia, and includes a coating of greater than 0 to about 10 weight percent of a phosphorous containing compound. In alternative embodiments, the fiber comprises the fiberization product of about 65 to about 86 weight percent silica, about 14 to about 35 weight percent magnesia, and includes a coating of from about 5 to about 10 weight percent based on the total fiber weight of a phosphorous containing compound. In alternative embodiments, the inorganic fiber comprises the fiberization product of about 65 to about 86 weight percent silica and about 14 to about 35 weight percent magnesia, and greater than 0 to about 10 weight percent of a phosphorous containing compound as part of the fiber's melt chemistry and as a coating based on the total fiber weight. In alternative embodiments, the inorganic fiber comprises the fiberization product of about 65 to about 86 weight percent silica and about 14 to about 35 weight percent magnesia, and from about 5 to about 10 weight percent of a phosphorous containing compound as part of the fiber's melt chemistry and as a coating based on the total fiber weight.

According other embodiments, the fiber comprises the fiberization product of greater than 71.25 to about 86 weight percent silica, about 14 to about 28.75 weight percent magnesia and greater than 0 to about 10 weight percent of a phosphorous containing compound. In alternative embodiments, the magnesium-silicate phosphorous containing fiber comprises the fiberization product of greater than 71.25 to about 86 weight percent silica and about 14 to about 28.75 weight percent magnesia, and includes a coating in an amount of greater than 0 to about 10 weight percent based on the total fiber weight of a phosphorous containing compound. In alternative embodiments, the inorganic fiber comprising the fiberization product of greater than 71.25 to about 86 weight percent silica and about 14 to about 28.75 weight percent magnesia also comprises greater than 0 to about 10 weight percent of a phosphorous containing compound as part of the fiber's melt chemistry and as a coating based on the total fiber weight.

According other embodiments, the fiber comprises the fiberization product of about 71.25 to about 86 weight percent silica, about 14 to about 28.75 weight percent magnesia, and greater than 0 to about 7 weight percent of a phosphorous containing compound. In alternative embodiments, the fiber comprises the fiberization product of about 71.25 to about 86 weight percent silica and about 14 to about 28.75 weight percent magnesia, and includes a coating in an amount of greater than 0 to about 7 weight percent based on the total fiber weight of a phosphorous containing compound. In alternative embodiments, the fiber comprising the fiberization product of about 71.25 to about 86 weight percent silica and about 14 to about 28.75 weight percent magnesia also comprises greater than 0 to about 7 weight percent of a phosphorous containing compound as part of the fiber's melt chemistry and as a coating based on the total fiber weight.

According other embodiments, the fiber comprises the fiberization product of greater than 71.25 to about 86 weight percent silica, about 14 to about 28.75 weight percent magnesia and greater than 0 to about 6 weight percent of a phosphorous containing compound. In alternative embodiments, the fiber comprises the fiberization product of greater than 71.25 to about 86 weight percent silica and about 14 to about 28.75 weight percent magnesia, and includes a coating in an amount of greater than 0 to about 6 weight percent based on the total fiber weight of a phosphorous containing compound. In alternative embodiments, the fiber comprising the fiberization product of greater than 71.25 to about 86 weight percent silica and about 14 to about 28.75 weight percent magnesia also comprises greater than 0 to about 6 weight percent of a phosphorous containing compound as part of the fiber's melt chemistry and as a coating based on the total fiber weight.

According other embodiments, the fiber comprises the fiberization product of greater than 71.25 to about 86 weight percent silica, about 14 to about 28.75 weight percent magnesia, and greater than 0 to about 5 weight percent of a phosphorous containing compound. In alternative embodiments, the fiber comprises the fiberization product of greater than 71.25 to about 86 weight percent silica and about 14 to about 28.75 weight percent magnesia, and includes a coating in an amount of greater than 0 to about 5 weight percent based on the total fiber weight of a phosphorous containing compound. In alternative embodiments, the fiber comprising the fiberization product of greater than 71.25 to about 86 weight percent silica and about 14 to about 28.75 weight percent magnesia also comprises greater than 0 to about 5 weight percent of a phosphorous containing compound as part of the fiber's melt chemistry and as a coating based on the total fiber weight.

According other embodiments, the fiber comprises the fiberization product of greater than 71.25 to about 86 weight percent silica, about 14 to about 28.75 weight percent magnesia, and greater than 0 to about 4 weight percent of a phosphorous containing compound. In alternative embodiments, the fiber comprises the fiberization product of greater than 71.25 to about 86 weight percent silica and about 14 to about 28.75 weight percent magnesia, and includes a coating in an amount of greater than 0 to about 4 weight percent based on the total fiber weight of a phosphorous containing compound. In alternative embodiments, the fiber comprising the fiberization product of greater than 71.25 to about 86 weight percent silica and about 14 to about 28.75 weight percent magnesia also comprises greater than 0 to about 4 weight percent of a phosphorous containing compound as part of the fiber's melt chemistry and as a coating based on the total fiber weight.

According other embodiments, the fiber comprises the fiberization product of greater than 71.25 to about 86 weight percent silica, about 14 to about 28.75 weight percent magnesia, and greater than 0 to about 3 weight percent of a phosphorous containing compound. In alternative embodiments, the fiber comprises the fiberization product of greater than 71.25 to about 86 weight percent silica and about 14 to about 28.75 weight percent magnesia, and includes a coating in an amount of greater than 0 to about 3 weight percent based on the total fiber weight of a phosphorous containing compound. In alternative embodiments, the fiber comprising the fiberization product of greater than 71.25 to about 86 weight percent silica and about 14 to about 28.75 weight percent magnesia also comprises greater than 0 to about 3 weight percent of a phosphorous containing compound as part of the fiber's melt chemistry and as a coating based on the total fiber weight.

According other embodiments, the fiber comprises the fiberization product of greater than 71.25 to about 86 weight percent silica, about 14 to about 28.75 weight percent magnesia, and greater than 0 to about 2 weight percent of a phosphorous containing compound. In alternative embodiments, the fiber comprises the fiberization product of greater than 71.25 to about 86 weight percent silica and about 14 to about 28.75 weight percent magnesia, and includes a coating in an amount of greater than 0 to about 2 weight percent based on the total fiber weight of a phosphorous containing compound. In alternative embodiments, the fiber comprising the fiberization product of greater than 71.25 to about 86 weight percent silica and about 14 to about 28.75 weight percent magnesia also comprises greater than 0 to about 2 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to about 10 weight percent of a phosphorous containing compound. In alternative embodiments, the magnesium-silicate phosphorous containing fiber comprises the fiberization product of about 70 to about 80 weight percent silica and about 15 to about 25 weight percent magnesia, and includes a coating of a phosphorous containing compound in an amount of greater than 0 to about 10 weight percent based on the total fiber weight. In alternative embodiments, the inorganic fiber comprising the fiberization product of about 70 to about 80 weight percent silica and about 15 to about 25 weight percent magnesia also comprises greater than 0 to about 10 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to about 7 weight percent of a phosphorous containing compound. In alternative embodiments, the fiber comprises the fiberization product of about 70 to about 80 weight percent silica and about 15 to about 25 weight percent magnesia and includes a coating of a phosphorous containing compound in an amount of greater than 0 to about 7 weight percent based on the total fiber weight. In alternative embodiments, the fiber comprising the fiberization product of about 70 to about 80 weight percent silica and about 15 to about 25 weight percent magnesia also comprises greater than 0 to about 7 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to about 6 weight percent of a phosphorous containing compound. In alternative embodiments, the fiber comprises the fiberization product of about 70 to about 80 weight percent silica and about 15 to about 25 weight percent magnesia, and a includes coating of a phosphorous containing compound in an amount of greater than 0 to about 6 weight percent based on the total fiber weight. In alternative embodiments, the fiber comprising the fiberization product of about 70 to about 80 weight percent silica and about 15 to about 25 weight percent magnesia also comprises greater than 0 to about 6 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to about 5 weight percent of a phosphorous containing compound. In alternative embodiments, the fiber comprises the fiberization product of about 70 to about 80 weight percent silica and about 15 to about 25 weight percent magnesia, and includes a coating of a phosphorous containing compound in an amount of greater than 0 to about 5 weight percent based on the total fiber weight. In alternative embodiments, the fiber comprising the fiberization product of about 70 to about 80 weight percent silica and about 15 to about 25 weight percent magnesia also comprises greater than 0 to about 5 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to about 4 weight percent of a phosphorous containing compound. In alternative embodiments, the fiber comprises the fiberization product of about 70 to about 80 weight percent silica and about 15 to about 25 weight percent magnesia, and includes a coating of a phosphorous containing compound in an amount of greater than 0 to about 4 weight percent based on the total fiber weight. In alternative embodiments, the fiber comprising the fiberization product of about 70 to about 80 weight percent silica and about 15 to about 25 weight percent magnesia also comprises greater than 0 to about 4 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to about 3 weight percent of a phosphorous containing compound. In alternative embodiments, the fiber comprises the fiberization product of about 70 to about 80 weight percent silica and about 15 to about 25 weight percent magnesia, and includes a coating of a phosphorous containing compound in an amount of greater than 0 to about 3 weight percent based on the total fiber weight. In alternative embodiments, the fiber comprising the fiberization product of about 70 to about 80 weight percent silica and about 15 to about 25 weight percent magnesia also comprises greater than 0 to about 3 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to about 2 weight percent of a phosphorous containing compound. In alternative embodiments, the fiber comprises the fiberization product of about 70 to about 80 weight percent silica and about 15 to about 25 weight percent magnesia, and includes a coating of a phosphorous containing compound in an amount of greater than 0 to about 2 weight percent based on the total fiber weight. In alternative embodiments, the fiber comprising the fiberization product of about 70 to about 80 weight percent silica and about 15 to about 25 weight percent magnesia also comprises greater than 0 to about 2 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to about 1.5 weight percent of a phosphorous containing compound. In alternative embodiments, the fiber comprises the fiberization product of about 70 to about 80 weight percent silica and about 15 to about 25 weight percent magnesia, and includes a coating of a phosphorous containing compound in an amount of greater than 0 to about 1.5 weight percent based on the total fiber weight. In alternative embodiments, the fiber comprising the fiberization product of about 70 to about 80 weight percent silica and about 15 to about 25 weight percent magnesia also comprises greater than 0 to about 1.5 weight percent of a phosphorous containing compound as part of the fiber's melt chemistry and as a coating based on the total fiber weight.

According other embodiments, the fiber comprises the fiberization product of about 70 to about 80 weight percent silica, about 15 to about 25 weight percent magnesia, and greater than 0 to less than 1 weight percent of a phosphorous containing compound. In alternative embodiments, the fiber comprises the fiberization product of about 70 to about 80 weight percent silica and about 15 to about 25 weight percent magnesia, and includes a coating of a phosphorous containing compound in an amount of greater than 0 to less than 1 weight percent based on the total fiber weight. In alternative embodiments, the fiber comprising the fiberization product of about 70 to about 80 weight percent silica and about 15 to about 25 weight percent magnesia also comprises greater than 0 to less than 1 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to about 10 weight percent of a phosphorous containing compound. In alternative embodiments, the magnesium-silicate phosphorous containing fiber comprises the fiberization product of about 72 to about 80 weight percent silica and about 15 to about 25 weight percent magnesia, and includes a coating of a phosphorous containing compound in an amount of greater than 0 to about 10 weight percent based on the total fiber weight. In alternative embodiments, the inorganic fiber comprising the fiberization product of about 72 to about 80 weight percent silica and about 15 to about 25 weight percent magnesia also comprises greater than 0 to about 10 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to about 7 weight percent of a phosphorous containing compound. In alternative embodiments, the fiber comprises the fiberization product of about 72 to about 80 weight percent silica and about 15 to about 25 weight percent magnesia, and includes a coating of a phosphorous containing compound in an amount of greater than 0 to about 7 weight percent based on the total fiber weight. In alternative embodiments, the fiber comprising the fiberization product of about 72 to about 80 weight percent silica and about 15 to about 25 weight percent magnesia also comprises greater than 0 to about 7 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to about 6 weight percent of a phosphorous containing compound. In alternative embodiments, the fiber comprises the fiberization product of about 72 to about 80 weight percent silica and about 15 to about 25 weight percent magnesia, and includes a coating of a phosphorous containing compound in an amount of greater than 0 to about 6 weight percent based on the total fiber weight. In alternative embodiments, the fiber comprising the fiberization product of about 72 to about 80 weight percent silica and about 15 to about 25 weight percent magnesia also comprises greater than 0 to about 6 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to about 5 weight percent of a phosphorous containing compound. In alternative embodiments, the fiber comprises the fiberization product of about 72 to about 80 weight percent silica and about 15 to about 25 weight percent magnesia, and includes a coating of a phosphorous containing compound in an amount of greater than 0 to about 5 weight percent based on the total fiber weight. In alternative embodiments, the fiber comprising the fiberization product of about 72 to about 80 weight percent silica and about 15 to about 25 weight percent magnesia also comprises greater than 0 to about 5 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to about 4 weight percent of a phosphorous containing compound. In alternative embodiments, the fiber comprises the fiberization product of about 72 to about 80 weight percent silica and about 15 to about 25 weight percent magnesia, and includes a coating of a phosphorous containing compound in an amount of greater than 0 to about 4 weight percent based on the total fiber weight. In alternative embodiments, the fiber comprising the fiberization product of about 72 to about 80 weight percent silica and about 15 to about 25 weight percent magnesia also comprises greater than 0 to about 4 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to about 3 weight percent of a phosphorous containing compound. In alternative embodiments, the fiber comprises the fiberization product of about 72 to about 80 weight percent silica and about 15 to about 25 weight percent magnesia, and includes a coating of a phosphorous containing compound in an amount of greater than 0 to about 3 weight percent based on the total fiber weight. In alternative embodiments, the fiber comprising the fiberization product of about 72 to about 80 weight percent silica and about 15 to about 25 weight percent magnesia also comprises greater than 0 to about 3 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to about 2 weight percent of a phosphorous containing compound. In alternative embodiments, the fiber comprises the fiberization product of about 72 to about 80 weight percent silica and about 15 to about 25 weight percent magnesia and a coating of a phosphorous containing compound in an amount of greater than 0 to about 2 weight percent based on the total fiber weight. In alternative embodiments, the fiber comprising the fiberization product of about 72 to about 80 weight percent silica and about 15 to about 25 weight percent magnesia also comprises greater than 0 to about 2 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to about 1.5 weight percent of a phosphorous containing compound. In alternative embodiments, the fiber comprises the fiberization product of about 72 to about 80 weight percent silica and about 15 to about 25 weight percent magnesia, and includes a coating of a phosphorous containing compound in an amount of greater than 0 to about 1.5 weight percent based on the total fiber weight. In alternative embodiments, the fiber comprising the fiberization product of about 72 to about 80 weight percent silica and about 15 to about 25 weight percent magnesia also comprises greater than 0 to about 1.5 weight percent of a phosphorous containing compound as part of the fiber's melt chemistry and as a coating based on the total fiber weight.

According other embodiments, the fiber comprises the fiberization product of about 72 to about 80 weight percent silica, about 15 to about 25 weight percent magnesia, and greater than 0 to less than 1 weight percent of a phosphorous containing compound. In alternative embodiments, the fiber comprises the fiberization product of about 72 to about 80 weight percent silica and about 15 to about 25 weight percent magnesia, and includes a coating of a phosphorous containing compound in an amount of greater than 0 to less than 1 weight percent based on the total fiber weight. In alternative embodiments, the fiber comprising the fiberization product of about 72 to about 80 weight percent silica and about 15 to about 25 weight percent magnesia also comprises greater than 0 to less than 1 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to about 10 weight percent of a phosphorous containing compound. In alternative embodiments, the magnesium-silicate phosphorous containing fiber comprises the fiberization product of about 75 to about 79 weight percent silica and about 15 to about 20 weight percent magnesia, and includes a coating of a phosphorous containing compound in an amount of greater than 0 to about 10 weight percent based on the total fiber weight. In alternative embodiments, the inorganic fiber comprising the fiberization product of about 75 to about 79 weight percent silica and about 15 to about 20 weight percent magnesia also comprises greater than 0 to about 10 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to about 7 weight percent of a phosphorous containing compound. In alternative embodiments, the fiber comprises the fiberization product of about 75 to about 79 weight percent silica and about 15 to about 20 weight percent magnesia, and includes a coating of a phosphorous containing compound in an amount of greater than 0 to about 7 weight percent based on the total fiber weight. In alternative embodiments, the fiber comprising the fiberization product of about 75 to about 79 weight percent silica and about 15 to about 20 weight percent magnesia also comprises greater than 0 to about 7 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to about 6 weight percent of a phosphorous containing compound. In alternative embodiments, the fiber comprises the fiberization product of about 75 to about 79 weight percent silica and about 15 to about 20 weight percent magnesia and a coating of a phosphorous containing compound in an amount of greater than 0 to about 6 weight percent based on the total fiber weight. In alternative embodiments, the fiber comprising the fiberization product of about 75 to about 79 weight percent silica and about 15 to about 20 weight percent magnesia also comprises greater than 0 to about 6 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to about 5 weight percent of a phosphorous containing compound. In alternative embodiments, the fiber comprises the fiberization product of about 75 to about 79 weight percent silica and about 15 to about 20 weight percent magnesia, and includes a coating of a phosphorous containing compound in an amount of greater than 0 to about 5 weight percent based on the total fiber weight. In alternative embodiments, the fiber comprising the fiberization product of about 75 to about 79 weight percent silica and about 15 to about 20 weight percent magnesia also comprises greater than 0 to about 5 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to about 4 weight percent of a phosphorous containing compound. In alternative embodiments, the fiber comprises the fiberization product of about 75 to about 79 weight percent silica and about 15 to about 20 weight percent magnesia, and includes a coating of a phosphorous containing compound in an amount of greater than 0 to about 4 weight percent based on the total fiber weight. In alternative embodiments, the fiber comprising the fiberization product of about 75 to about 79 weight percent silica and about 15 to about 20 weight percent magnesia also comprises greater than 0 to about 4 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to about 3 weight percent of a phosphorous containing compound. In alternative embodiments, the fiber comprises the fiberization product of about 75 to about 79 weight percent silica and about 15 to about 20 weight percent magnesia, and includes a coating of a phosphorous containing compound in an amount of greater than 0 to about 3 weight percent based on the total fiber weight. In alternative embodiments, the fiber comprising the fiberization product of about 75 to about 79 weight percent silica and about 15 to about 20 weight percent magnesia also comprises greater than 0 to about 3 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to about 2 weight percent of a phosphorous containing compound. In alternative embodiments, the fiber comprises the fiberization product of about 75 to about 79 weight percent silica and about 15 to about 20 weight percent magnesia, and includes a coating of a phosphorous containing compound in an amount of greater than 0 to about 2 weight percent based on the total fiber weight. In alternative embodiments, the fiber comprising the fiberization product of about 75 to about 79 weight percent silica and about 15 to about 20 weight percent magnesia also comprises greater than 0 to about 2 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to about 1.5 weight percent of a phosphorous containing compound. In alternative embodiments, the fiber comprises the fiberization product of about 75 to about 79 weight percent silica and about 15 to about 20 weight percent magnesia, and includes a coating of a phosphorous containing compound in an amount of greater than 0 to about 1.5 weight percent based on the total fiber weight. In alternative embodiments, the fiber comprising the fiberization product of about 75 to about 79 weight percent silica and about 15 to about 20 weight percent magnesia also comprises greater than 0 to about 1.5 weight percent of a phosphorous containing compound as part of the fiber's melt chemistry and as a coating based on the total fiber weight.

According other embodiments, the fiber comprises the fiberization product of about 75 to about 79 weight percent silica, about 15 to about 20 weight percent magnesia, and greater than 0 to less than 1 weight percent of a phosphorous containing compound. In alternative embodiments, the fiber comprises the fiberization product of about 75 to about 79 weight percent silica and about 15 to about 20 weight percent magnesia, and includes a coating of a phosphorous containing compound in an amount of greater than 0 to less than 1 weight percent based on the total fiber weight. In alternative embodiments, the fiber comprising the fiberization product of about 75 to about 79 weight percent silica and about 15 to about 20 weight percent magnesia also comprises greater than 0 to less than 1 weight percent of a phosphorous containing compound as part of the fiber's melt chemistry and as a coating based on the total fiber weight.

According other embodiments, the fiber comprises the fiberization product of about 72 to about 80 weight percent silica, about 20 to about 28 weight percent magnesia, and greater than 0 to about 10 weight percent of a phosphorous containing compound. In alternative embodiments, the magnesium-silicate phosphorous containing fiber comprises the fiberization product of about 72 to about 80 weight percent silica and about 20 to about 28 weight percent magnesia, and includes a coating of a phosphorous containing compound in an amount of greater than 0 to about 10 weight percent based on the total fiber weight. In alternative embodiments, the inorganic fiber comprising the fiberization product of about 72 to about 80 weight percent silica and about 20 to about 28 weight percent magnesia also comprises greater than 0 to about 10 weight percent of a phosphorous containing compound as part of the fiber's melt chemistry and as a coating based on the total fiber weight.

According other embodiments, the fiber comprises the fiberization product of about 72 to about 80 weight percent silica, about 20 to about 28 weight percent magnesia, and greater than 0 to about 7 weight percent of a phosphorous containing compound. In alternative embodiments, the fiber comprises the fiberization product of about 72 to about 80 weight percent silica and about 20 to about 28 weight percent magnesia, and includes a coating of a phosphorous containing compound in an amount of greater than 0 to about 7 weight percent based on the total fiber weight. In alternative embodiments, the fiber comprising the fiberization product of about 72 to about 80 weight percent silica and about 20 to about 28 weight percent magnesia also comprises greater than 0 to about 7 weight percent of a phosphorous containing compound as part of the fiber's melt chemistry and as a coating based on the total fiber weight.

According other embodiments, the fiber comprises the fiberization product of about 72 to about 80 weight percent silica, about 20 to about 28 weight percent magnesia, and greater than 0 to about 6 weight percent of a phosphorous containing compound. In alternative embodiments, the fiber comprises the fiberization product of about 72 to about 80 weight percent silica and about 20 to about 28 weight percent magnesia, and includes a coating of a phosphorous containing compound in an amount of greater than 0 to about 6 weight percent based on the total fiber weight. In alternative embodiments, the fiber comprising the fiberization product of about 72 to about 80 weight percent silica and about 20 to about 28 weight percent magnesia also comprises greater than 0 to about 6 weight percent of a phosphorous containing compound as part of the fiber's melt chemistry and as a coating based on the total fiber weight.

According other embodiments, the fiber comprises the fiberization product of about 72 to about 80 weight percent silica, about 20 to about 28 weight percent magnesia, and greater than 0 to about 5 weight percent of a phosphorous containing compound. In alternative embodiments, the fiber comprises the fiberization product of about 72 to about 80 weight percent silica and about 20 to about 28 weight percent magnesia, and including a coating of a phosphorous containing compound in an amount of greater than 0 to about 5 weight percent based on the total fiber weight. In alternative embodiments, the fiber comprising the fiberization product of about 72 to about 80 weight percent silica and about 20 to about 28 weight percent magnesia also comprises greater than 0 to about 5 weight percent of a phosphorous containing compound as part of the fiber's melt chemistry and as a coating based on the total fiber weight.

According other embodiments, the fiber comprises the fiberization product of about 72 to about 80 weight percent silica, about 20 to about 28 weight percent magnesia, and greater than 0 to about 4 weight percent of a phosphorous containing compound. In alternative embodiments, the fiber comprises the fiberization product of about 72 to about 80 weight percent silica and about 20 to about 28 weight percent magnesia, and includes a coating of a phosphorous containing compound in an amount of greater than 0 to about 4 weight percent based on the total fiber weight. In alternative embodiments, the fiber comprising the fiberization product of about 72 to about 80 weight percent silica and about 20 to about 28 weight percent magnesia also comprises greater than 0 to about 4 weight percent of a phosphorous containing compound as part of the fiber's melt chemistry and as a coating based on the total fiber weight.

According other embodiments, the fiber comprises the fiberization product of about 72 to about 80 weight percent silica, about 20 to about 28 weight percent magnesia, and greater than 0 to about 3 weight percent of a phosphorous containing compound. In alternative embodiments, the fiber comprises the fiberization product of about 72 to about 80 weight percent silica and about 20 to about 28 weight percent magnesia, and includes a coating of a phosphorous containing compound in an amount of greater than 0 to about 3 weight percent based on the total fiber weight. In alternative embodiments, the fiber comprising the fiberization product of about 72 to about 80 weight percent silica and about 20 to about 28 weight percent magnesia also comprises greater than 0 to about 3 weight percent of a phosphorous containing compound as part of the fiber's melt chemistry and as a coating based on the total fiber weight.

According other embodiments, the fiber comprises the fiberization product of about 72 to about 80 weight percent silica, about 21 to about 28 weight percent magnesia, and greater than 0 to about 2 weight percent of a phosphorous containing compound. In alternative embodiments, the fiber comprises the fiberization product of about 72 to about 80 weight percent silica and about 20 to about 28 weight percent magnesia, and includes a coating of a phosphorous containing compound in an amount of greater than 0 to about 2 weight percent based on the total fiber weight. In alternative embodiments, the fiber comprising the fiberization product of about 72 to about 80 weight percent silica and about 20 to about 28 weight percent magnesia also comprises greater than 0 to about 2 weight percent of a phosphorous containing compound as part of the fiber's melt chemistry and as a coating based on the total fiber weight.

According other embodiments, the fiber comprises the fiberization product of about 72 to about 80 weight percent silica, about 20 to about 28 weight percent magnesia, and greater than 0 to about 1.5 weight percent of a phosphorous containing compound. In alternative embodiments, the fiber comprises the fiberization product of about 72 to about 80 weight percent silica and about 20 to about 28 weight percent magnesia, and includes a coating of a phosphorous containing compound in an amount of greater than 0 to about 1.5 weight percent based on the total fiber weight. In alternative embodiments, the fiber comprising the fiberization product of about 72 to about 80 weight percent silica and about 20 to about 28 weight percent magnesia also comprises greater than 0 to about 1.5 weight percent of a phosphorous containing compound as part of the fiber's melt chemistry and as a coating based on the total fiber weight.

According other embodiments, the fiber comprises the fiberization product of about 72 to about 80 weight percent silica, about 20 to about 28 weight percent magnesia, and greater than 0 to less than 1 weight percent of a phosphorous containing compound. In alternative embodiments, the fiber comprises the fiberization product of about 72 to about 80 weight percent silica and about 20 to about 28 weight percent magnesia, and includes a coating of a phosphorous containing compound in an amount of greater than 0 to less than 1 weight percent based on the total fiber weight. In alternative embodiments, the fiber comprising the fiberization product of about 72 to about 80 weight percent silica and about 20 to about 28 weight percent magnesia also comprises greater than 0 to less than 1 weight percent of a phosphorous containing compound as part of the fiber's melt chemistry and as a coating based on the total fiber weight.

In addition to magnesia, silica and phosphorous, the magnesium-silicate phosphorous containing fiber may contain a number of impurities. In certain embodiments, the magnesium-silicate phosphorous containing fiber may contain up to about 10 weight percent of impurities. Such impurities may include calcia and iron oxides. In certain embodiments, the fiber does not contain more than about 1 weight percent calcia impurity. In other embodiments, the fiber contains less than 0.5 weight percent calcia impurity. In other embodiments, the fiber contains less than 0.3 weight percent calcia. According to other embodiments, the fiber does not contain more than about 2 weight percent iron oxides impurity (calculated as Fe₂O₃).

The magnesium-silicate phosphorous containing fibers exhibit a linear shrinkage after exposure to a service temperature of 1260° C. for 24 hours of less than 3.5 percent. In other embodiments, the magnesium-silicate phosphorous containing fibers exhibit a linear shrinkage after exposure to a service temperature of 1260° C. for 24 hours of less than 2.0 percent.

In other embodiments, the magnesium-silicate phosphorous containing fibers exhibit a linear shrinkage after exposure to a service temperature of 1400° C. for 24 hours of less than 10 percent. In other embodiments, the magnesium-silicate phosphorous containing fibers exhibit a linear shrinkage after exposure to a service temperature of 1400° C. for 24 hours of less than 5 percent. In other embodiments, the magnesium-silicate phosphorous containing fibers exhibit a linear shrinkage after exposure to a service temperature of 1400° C. for 24 hours of less than 4 percent. In other embodiments, the magnesium-silicate phosphorous containing fibers exhibit a linear shrinkage after exposure to a service temperature of 1400° C. for 24 hours of less than 3.5 percent. In other embodiments, the magnesium-silicate phosphorous containing fibers exhibit a linear shrinkage after exposure to a service temperature of 1400° C. for 24 hours of less than 2.5 percent. In other embodiments, the magnesium-silicate phosphorous containing fibers exhibit a linear shrinkage after exposure to a service temperature of 1400° C. for 24 hours of less than 2 percent.

According to certain embodiments, a fiber comprising the fiberization product comprising of about 65 to about 86 weight percent silica and about 14 to about 35 weight percent magnesia, greater than 0 to about 10 weight percent of a phosphorous containing compound, and greater than 0 to about 1.5 weight percent alumina exhibits a linear shrinkage of about 5% or less at 1260° C. for 24 hours.

According to certain embodiments, a fiber comprising the fiberization product comprising of about 65 to about 86 weight percent silica and about 14 to about 35 weight percent magnesia, greater than 0 to about 10 weight percent of a phosphorous containing compound, and greater than 0 to about 3 weight percent alumina exhibits a linear shrinkage of about 15% or less at 1260° C. for 24 hours.

According to certain embodiments, a fiber comprising the fiberization product comprising of about 65 to about 86 weight percent silica and about 14 to about 35 weight percent magnesia, greater than 0 to about 10 weight percent of a phosphorous containing compound, and greater than 0 to about 4 weight percent alumina exhibits a linear shrinkage of about 20% or less at 1260° C. for 24 hours.

Thus, the magnesium-silicate phosphorous containing fibers are useful for thermal insulating applications at continuous service or operating temperatures of at least 1260° C. or greater. According to certain embodiments, the magnesium-silicate phosphorous containing fibers are useful for thermal insulating applications at continuous service or operating temperatures of at least 1400° C. or greater. Furthermore, it has been found that the magnesium-silicate phosphorous containing fibers do not melt until they are exposed to a temperature of 1500° C. or greater.

The magnesium-silicate phosphorous containing fiber may be prepared by fiber blowing or fiber spinning techniques. A suitable fiber blowing technique includes the steps of mixing the starting raw materials containing magnesia, silica and, phosphorous containing compound together to form a material mixture of ingredients, introducing the material mixture of ingredients into a suitable vessel or container, melting the material mixture of ingredients for discharge through a suitable nozzle, and blowing a high pressure gas onto the discharged flow of molten material mixture of ingredients to form the magnesium-silicate phosphorous containing fibers.

A suitable fiber spinning technique includes the steps of mixing the starting raw materials containing magnesia, silica and phosphorous containing compound together to form a material mixture of ingredients, introducing the material mixture of ingredients into a suitable vessel or container, melting the material mixture of ingredients for discharge through a suitable nozzle onto spinning wheels. The molten stream then cascades over the wheels, coating the wheels and being thrown off through centripetal forces, thereby forming fibers.

In some embodiments, the fiber is produced from a melt of raw materials by subjecting the molten stream to a jet of high pressure/high velocity air or by pouring the melt onto rapidly spinning wheels and spinning fiber centrifugally. If phosphorous pentoxide is provided as an additive to the melt, then a suitable phosphorous pentoxide bearing raw material is simply added at the proper amount to the raw materials being melted. Phosphorous pentoxide may be added as magnesium phosphate, ammonium phosphate or any other form of phosphate compatible with the overall chemistry. The addition of phosphorous pentoxide to the melt may range from greater than 0 to about 5 weight percent or greater.

The addition of a phosphorous containing compound as a component of the raw materials which are fiberized or as a coating which is applied to the exterior surfaces of the fiber results in a decrease of linear shrinkage of the resulting fiber after exposure to the use temperature. In addition to improvements in shrinkage, the addition of a phosphorous containing compound as a component of the raw materials which are fiberized decreases the temperature of solidification and results in an improved viscosity of the fiberization melt. In certain embodiments, the addition of a phosphorous containing compound to the fiberization melt decreases the solidification temperature about 50° C. Thus, the phosphorous containing compound may function as a viscosity modifier in certain embodiments.

In addition to the phosphorous containing compound, the viscosity of the material melt of ingredients may optionally be controlled by the presence of viscosity modifiers, in an amount sufficient to provide the fiberization required for the desired applications. The viscosity modifiers may be present in the raw materials which supply the main components of the melt, or may, at least in part, be separately added. Desired particle size of the raw materials is determined by furnacing conditions, including furnace size (SEF), pour rate, melt temperature, residence time, and the like.

A compound containing a lanthanide series element may be utilized to enhance the viscosity of a fiber melt containing silica and magnesia as major components, thereby enhancing the fiberizability of the fiber melt. Other compounds which may be utilized to enhance the viscosity of the fiber melt include alumina, boria or combinations of alumina and boria. In certain embodiments, it is desirable to limit the amount of alumina present in the fiber melt chemistry to at least below about 2 weight percent, and, if possible, with raw materials used, to less than about 1 weight percent. Other elements or compounds may be utilized as viscosity modifiers which, when added to the melt, affect the melt viscosity so as to approximate the profile, or shape, of the viscosity/temperature curve of a melt that is readily fiberizable.

While it is not necessary that the entire exterior surface area of the individual fibers be coated with a phosphorous containing compound, a sufficient portion of the surface area may be coated with the phosphorous compound coating to provide a magnesium-silicate fiber having a continuous use or service temperature of at least 1400° C. Thus, according certain embodiments, a portion of the exterior surfaces of the fiber is coated with a phosphorous containing compound. According to other embodiments, substantially all of the exterior surface of the fiber is coated with a phosphorous containing compound. According to yet further embodiments, the entire exterior surface of the fiber is coated with the phosphorous containing compound.

The phosphorous containing compound precursor that is used to form the coating on the at least a portion of the surface of the magnesium-silicate fiber may include phosphoric acid in its various forms, such as a metaphosphoric acid, orthophosphoric acid, polyphosphoric acid, superphosphoric acid, any water soluble salt of phosphoric acid that includes the —PO₄ group, and mixtures thereof.

Metal phosphates are suitable for forming the coating of the surfaces of the magnesium-silicate fibers to increase the temperature resistance of the fibers. According to certain embodiments, the metal phosphates that may be utilized to coat the surfaces of the magnesium-silicate fibers include the alkali metal phosphates and the alkaline earth metal phosphates, ammonium phosphates, or mixtures thereof. Without limitation, suitable alkali metal phosphates may include lithium phosphates, sodium phosphates, and potassium phosphates. Without limitation, suitable alkaline earth metal phosphates include magnesium phosphate and calcium phosphate. Ammonium phosphate may also be used to coat the surfaces of the magnesium-silicate fiber.

The magnesium-silicate fibers having a phosphorous containing compound coating that is derived from a phosphorous containing compound precursor on at least a portion of the exterior fiber surfaces exhibit a linear shrinkage after exposure to a service temperature of 1400° C. for 24 hours of less than 4 percent. Thus, the coated magnesium-silicate fibers are useful for thermal insulating applications at continuous service or operating temperatures of at least 1400° C. or greater.

The coating containing a phosphorous compound may be applied to the exterior surfaces of the fiber either during the fiberization process (at the point of fiberization), or after the magnesium-silicate fibers have been fiberized. It is useful to apply the coating of the phosphorous compound on the fibers surfaces during the fiberization process. According to this technique, the coating containing the phosphorous compound is sprayed onto the surfaces of the fibers at the point of fiberization with a suitable spray apparatus having a nozzle for discharging the coating composition onto the fibers. That is, the coating composition containing a phosphorous compound is applied to the fibers as the fibers are discharged from the molten mixture of ingredients.

The coating containing the phosphorous compound may also be applied to the fiber surfaces after completion of the fiberization process by a number of techniques including, without limitation, dipping, immersing, impregnating, soaking, spraying, or splashing the fibers with the coating composition containing a phosphorous compound.

A method for preparing a low shrinkage, high temperature resistant, non-durable magnesium-silicate phosphorous containing fiber having a use temperature of at least 1400° C. or greater is provided. The method of forming the magnesium-silicate phosphorous containing fiber includes forming a material melt of ingredients comprising magnesia, silica, and a phosphorous containing compound and forming fibers from the melt of ingredients. In other embodiments, the method of forming the magnesium-silicate phosphorous containing fiber includes forming a material melt of ingredients comprising magnesia and silica, forming fibers from the melt of ingredients and coating the resulting fiber at the point of fiberization or after fiberization with a phosphorous containing compound. In other embodiments, the method of forming the magnesium-silicate phosphorous containing fiber includes forming a material melt of ingredients comprising magnesia, silica, and a phosphorous containing compound, forming fibers from the melt of ingredients and coating the resulting fiber at the point of fiberization or after fiberization with a phosphorous containing compound. The magnesium-silicate phosphorous containing fibers may be produced from the melt of ingredients by standard melt spinning or fiber blowing techniques.

The fiber may be manufactured with existing fiberization technology and formed into multiple thermal insulation product forms, including but not limited to bulk fibers, fiber-containing blankets, boards, papers, felts, mats, blocks, modules, coatings, cements, moldable compositions, pumpable compositions, putties, ropes, braids, wicking, textiles (such as cloths, tapes, sleeving, string, yarns, etc. . . . ), vacuum cast shapes and composites. The fiber may be used in combination with conventional materials utilized in the production of fiber-containing blankets, vacuum cast shapes and composites, as a substitute for conventional refractory ceramic fibers. The fiber may be used alone or in combination with other materials, such as binders and the like, in the production of fiber-containing paper and felt.

A method of insulating an article using a thermal insulation containing the magnesium-silicate phosphorous containing fibers is also provided. The method of insulating an article includes disposing on, in, near, or around the article to be insulated, a thermal insulation material that contains the magnesium-silicate phosphorous containing fibers. The magnesium-silicate phosphorous containing fibers included in the thermal insulation material comprise the fiberization product of about 65 to about 86 weight percent silica, about 14 to about 35 weight percent magnesia and greater than 0 to about 10 weight percent of a phosphorous containing compound.

A method of insulating an article using thermal insulation containing phosphorous coated magnesium-silicate fibers is also provided. The method of insulating an article includes disposing on, in, near, or around the article to be insulated, a thermal insulation material that contains phosphate coated magnesium-silicate fibers prepared in accordance with this process. The thermal insulation article comprises inorganic fibers comprising a fiberization product of about 65 to about 86 weight percent silica and about 14 to about 35 weight percent magnesia and wherein at least a portion of the fiber surface is coated with a phosphorous containing compound.

The high temperature resistant refractory inorganic fibers are readily manufacturable from a melt having a viscosity suitable for blowing or spinning fiber, are non-durable in physiological fluids, exhibit good mechanical strength up to the service temperature, exhibit excellent linear shrinkage up to 1400° C., and improved viscosity for fiberization.

### EXAMPLES

The following examples are set forth to describe illustrative embodiments of the magnesium-silicate phosphorous containing fibers in further detail and to illustrate the methods of preparing the inorganic fibers, preparing thermal insulating articles containing the fibers and using the fibers as thermal insulation. However, the examples should not be construed as limiting the fiber, the fiber containing articles, or the processes of making or using the fibers as thermal insulation in any manner.

### Linear Shrinkage

### Example 1

Magnesium-silicate phosphorous containing fibers were produced by a fiber blowing process from a melt comprising about 20.5 weight percent magnesia, about 78 weight percent silica, about 1.5 weight percent alumina impurity and magnesium phosphate in an amount sufficient to yield 3 weight percent measured as P₂O₅ of the fiberization product.

A shrinkage pad was prepared by mixing the blown fibers, a phenolic binder and water. The mixture of fibers, binder and water was poured into a sheet mold and the water was allowed to drawn through openings in the bottom of the mold. A 3 inch×5 inch test piece was cut from the pad and was used in the shrinkage testing. The length and width of the test pad was carefully measured. The test pad was then placed into a furnace and brought to a temperature of 1400° C. for 24 hours. After heating for 24 hours, the test pad was removed from the test furnace and cooled. After cooling, the length and width of the test pad were measured again. The linear shrinkage of the test pad was determined by comparing the “before” and “after” dimensional measurements. The test pad comprising fibers of Example 1 exhibited a linear shrinkage of about 1.9%.

### Example 2

Magnesium-silicate phosphorous containing fibers were produced by a fiber blowing process from a melt comprising about 20.5 weight percent magnesia, about 78 weight percent silica, about 1.5 weight percent alumina impurity and magnesium phosphate in an amount sufficient to yield 2 weight percent measured as P₂O₅ of the fiberization product.

The magnesium-silicate phosphorous containing fibers were formed into a test pad and the shrinkage characteristics of the test pad were determined according to the methods described for Example 1. The test pad comprising fibers manufactured from a melt of ingredients of Example 2 exhibited a linear shrinkage of from about 1.6% to about 1.9% after exposure to a use temperature 1260° C. for 24 hours and exhibited a linear shrinkage of from about 2.5% to about 3.1% after exposure to a use temperature of 1400° C. after 24 hours.

### Example 3

Magnesium-silicate phosphorous containing fibers were produced by a fiber blowing process from a melt comprising about 20.5 weight percent magnesia, about 78 weight percent silica, about 1.5 weight percent alumina impurity and magnesium phosphate in an amount sufficient to yield 1.5 weight percent measured as P₂O₅ of the fiberization product.

The magnesium-silicate phosphorous containing fibers were formed into a test pad and the shrinkage characteristics of the test pad were determined according to the methods described for Example 1. The test pad comprising fibers manufactured from a melt of ingredients of Example 3 exhibited a linear shrinkage of from about 3.1% after exposure to a use temperature 1260° C. for 24 hours and exhibited a linear shrinkage of from about 3.6% after exposure to a use temperature of 1400° C. after 24 hours.

### Example 4

Magnesium-silicate fibers were produced by a fiber blowing process from a melt comprising from about 18 to about 27 weight percent magnesia and from about 70 to about 80 weight percent silica. A solution of ammonium phosphate was prepared and sprayed onto the surface of the fibers during fiberization, thus coating a plurality of the fibers. The ammonium phosphate solution consisted of 160 g/l of diammonium phosphate and was sprayed onto the fibers at a rate of 200 ml/min. Melt pour rate was maintained at approximately 75-100 lb/hr. This was determined to be sufficient to provide a coating of 4.5 wt. % measured as P₂O₅ on the fibers. Needled fiber pads were prepared from this fiber and then tested at 1400° C. for 24 hours for shrinkage. Two shrinkage tests were conducted. Certain test pads of these fibers exhibited a shrinkage of 2.5% in the first test. Other test pads comprising these same fibers exhibited a shrinkage of 2.6% in the second test.

### Viscosity

### Example 5

Magnesium-silicate fibers were produced by a fiber blowing process from a melt comprising from about 18 to about 27 weight percent magnesia and from about 70 to about 80 weight percent silica and about 2 wt. % measured as P₂O₅. The addition of phosphate pentoxide modified the viscosity of the melt and resulted in a decrease in the solidification temperature from approximately 1780° C. to approximately 1730° C., thereby extending the working range of the melt by 50 degrees.

Additional samples of magnesium-silicate phosphorous containing fibers were prepared and tested for performance. The performance tests conducted included tests for linear shrinkage, compression recovery and dissolution rate within a physiological medium. The melt composition of these fiber samples and their corresponding test results for linear shrinkage, compression recovery and dissolution rate are provided in Table I and Table II below.

TABLE I

| Sample | SiO₂ | CaO | MgO | Al₂O₃ | Fe₂O₃ | P₂O₅ |
|---|---|---|---|---|---|---|
| 6 | 79 | 0.4 | 18.1 | 1.7 | 0.1 | 0.66 |
| 7 | 78 | 0.4 | 18.7 | 1.6 | 0.1 | 1.04 |
| 8 | 77.4 | 0.3 | 19 | 1.6 | 0.1 | 1.34 |
| 9 | 77.9 | 0.3 | 18.1 | 1.6 | 0.1 | 1.67 |
| 10 | 78.5 | 0.3 | 17.1 | 1.5 | 0.1 | 2 |
| 11 | 75.902 | 0.268 | 20.321 | 1.302 | 0.126 | 1.75 |
| 12 | 77.392 | 0.231 | 20.694 | 1.342 | 0.106 | 0.066 |
| 13 | 77.285 | | 20.067 | 1.274 | | 0.986 |
| 14 | 75.888 | 0.197 | 19.06 | 1.139 | 0.094 | 2.77 |
| 15 | 75.365 | 0.379 | 18.812 | 1.37 | 0 | 4.06 |
| 16 | 75.643 | 0.221 | 18.826 | 1.388 | 0.109 | 2.665 |
| 17 | 78.791 | 0.203 | 17.219 | 1.293 | 0.05 | 1.81 |
| 18 | 79.199 | 0.167 | 18.133 | 0.117 | 0.049 | 1.72 |
| 19 | 78.142 | 0.151 | 15.551 | 3.707 | 0.038 | 1.53 |
| C20 | 62.66 | 0.25 | 35.63 | 0.96 | 0.23 | 0 |
| C21 | 63.25 | 0.25 | 34.35 | 1.05 | 0.11 | 0.96 |
| C22 | 61.83 | 0.25 | 34.86 | 0.98 | 0.13 | 1.91 |
| 23 | 69.5 | 0.54 | 28.23 | 1.53 | 0.15 | 0 |
| 24 | 72.5 | 0.19 | 24.99 | 1.01 | 0.09 | 1.01 |
| 25 | 71.99 | 0.18 | 24.64 | 1.1 | 0.09 | 1.95 |
| 26 | 77.5 | 0.36 | 20.3 | 1.23 | 0.16 | 0.4 |
| 27 | 77.4 | 0.36 | 20.2 | 1.23 | 0.16 | 0.62 |
| 28 | 78.2 | 0.33 | 18.5 | 1.26 | 0.15 | 1.56 |
| 29 | 77.8 | 0.32 | 18.5 | 1.29 | 0.15 | 1.92 |
| 30 | 76.7 | 0.33 | 19.3 | 1.31 | 0.15 | 2.22 |
| 31 | 77.4 | 0.33 | 18.7 | 1.29 | 0.16 | 2.09 |
| 32 | 77 | 0.33 | 19.1 | 1.3 | 0.16 | 2.14 |
| 33 | 78.2 | 0.32 | 18 | 1.27 | 0.15 | 2.07 |
| 34 | 77.8 | 0.32 | 18.1 | 1.31 | 0.16 | 2.36 |
| C35* | 53-57 | — | — | 43-47 | trace | — |
| C36** | 53-55 | — | — | 29-31 | — | — |
| C37*** | 70-80 | — | 18-27 | — | — | — |

*Blanket commercially available from Unifrax I LLC (Niagara Falls, NY, USA) under the designation DURABLANKET S.
**Blanket commercially available from Unifrax I LLC (Niagara Falls, NY, USA) under the designation DURABLANKET 2600; includes 15-17 weight percent ZrO₂.
***Blanket commercially available from Unifrax I LLC (Niagara Falls, NY, USA) under the designation ISOFRAX Blanket.

TABLE II

| | | | | | Compression Recovery | | | | |
|---|---|---|---|---|---|---|---|---|---|
| | Shrinkage (% of original) | | | | (% of original) | | | | |
| | 1260 C. | 1260 C. | 1400 C. | 1500 C. | 1260 C. | 1260 C. | 1400 C. | 1500 C. | Diss. Rate |
| Sample | 24 hrs | 168 hrs | 24 hrs | 24 hrs | 24 hrs | 168 hrs | 24 hrs | 24 hrs | ng/cm2 hr |
| 6 | 4.75 | | 5.85 | 11.66 | 6.99 | | 2.40 | 4.33 | 603 |
| 7 | 3.70 | | 4.25 | 7.94 | 6.31 | | 2.45 | 3.21 | 702 |
| 8 | 2.09 | | | 6.71 | 8.44 | | | 5.15 | 926 |
| 9 | | | 2.70 | | | | 6.09 | | |
| 10 | 2.07 | | 2.58 | 5.20 | 8.02 | | 6.65 | 4.45 | 1367 |
| 11 | | 3.30 | 4.30 | | | 7.14 | 4.27 | | 1069 |
| 12 | | 7.00 | 9.90 | | | 16.39 | 6.32 | | 669 |
| 13 | | 4.00 | 5.70 | | | 8.20 | 5.88 | | 915 |
| 14 | | 1.80 | 2.80 | | | 8.50 | 6.32 | | 3334 |
| 15 | | | 4.90 | | | | | | |
| 16 | 3.22 | | | | | | | | |
| 17 | | | 3.54 | | | | | | 1545 |
| 18 | | | 4.00 | | | | | | 6012 |
| 19 | | | 5.16 | | | | | | |
| C20 | 39.4 | — | 43 | — | | — | C20 | 39.4 | — |
| C21 | 60.1 | — | — | — | | — | C21 | 60.1 | — |
| C22 | 32 | — | — | — | | — | C22 | 32 | — |
| 23 | 11.8 | — | 31.1 | — | | — | 23 | 11.8 | — |
| 24 | 5.6 | — | 9.8 | — | 7.9 | — | 24 | 5.6 | — |
| 25 | 3.8 | — | 9 | — | 7.7 | — | 25 | 3.8 | — |
| 26 | 21.1 | — | 26.7 | — | 13 | — | 26 | 21.1 | — |
| 27 | 12.3 | — | 15.9 | — | 10 | — | 27 | 12.3 | — |
| 28 | 3.5 | — | 4.6 | 11.8 | 10 | — | 28 | 3.5 | — |
| 29 | 2.4 | — | 3.3 | 8.2 | 9 | — | 29 | 2.4 | — |
| 30 | 2.4 | — | 3.2 | 9.6 | 9 | — | 30 | 2.4 | — |
| 31 | 3 | — | 4.9 | 13.3 | 11 | — | 31 | 3 | — |
| 32 | 3.7 | — | 9.6 | 20.2 | 13 | — | 32 | 3.7 | — |
| 33 | 3.3 | — | 5.1 | 10.9 | 9 | — | 33 | 3.3 | — |
| 34 | 3.3 | — | 5.3 | 13.1 | 9 | — | 34 | 3.3 | — |
| C35 | 4.5 | — | 11.5 | — | 24.2 | — | 16.9 | — | 0 |
| C36 | — | 2.2 | 2.3 | — | — | 33.4 | 30 | — | — |
| C37 | 5.7 | 7.2 | 9.1 | 13.3 | 9.8 | 11.9 | 3.3 | — | 375 |

C = comparative

As is shown in Tables I and II above, magnesium-silicate fiber samples which included a phosphate addition, measured as P₂O₅, generally exhibited excellent linear shrinkage values. Compression recovery and dissolution rate remained satisfactory. The results for fiber composition examples containing high levels of alumina exhibit excellent linear shrinkage (less than 5.2%) and dissolution in physiological fluid. This is quite surprising given the fact that it is known in the thermal insulating fiber art that the inclusion of high levels of alumina, such as at a level of 1.5 weight percent or more, in an alkaline earth silicate fiber results in high linear shrinkage and lower solubility as compared to fibers having lower levels of alumina.

Additional samples of magnesium-silicate fibers coated with a phosphorous containing compound were prepared and tested for performance. The performance tests conducted included tests for linear shrinkage, compression recovery and dissolution rate within a physiological medium. The melt composition of these fiber samples and their corresponding test results for linear shrinkage, compression recovery and dissolution rate are provided in Table III and Table IV below.

TABLE III

| Sample | SiO₂ | CaO | MgO | Al₂O₃ | Fe₂O₃ | P₂O₅ |
|---|---|---|---|---|---|---|
| 38 | 77.75 | 0.35 | 19.58 | 1.29 | 0.17 | 0.80 |
| 39 | 77.19 | 0.36 | 20.02 | 1.31 | 0.17 | 0.87 |
| 40 | 75.1 | 0.22 | 20.1 | 1.29 | 0.10 | 3.10 |
| 41 | 76.95 | 0.23 | 20.38 | 1.23 | 0.10 | 0.97 |
| 42 | 77.49 | 0.23 | 20.35 | 1.22 | 0.10 | 0.49 |
| C43 | 62.66 | 0.25 | 35.63 | 0.96 | 0.23 | 0 |
| C44 | 62.66 | 0.25 | 35.63 | 0.96 | 0.23 | 2.86 |
| C45 | 62.66 | 0.25 | 35.63 | 0.96 | 0.23 | 5.61 |
| 46 | 69.5 | 0.54 | 28.23 | 1.53 | 0.15 | 0 |
| 47 | 69.5 | 0.54 | 28.23 | 1.53 | 0.15 | 1.48 |
| 48 | 69.5 | 0.54 | 28.23 | 1.53 | 0.15 | 4.69 |
| 49 | 77.99 | 0.18 | 20.43 | 1.24 | 0.09 | 0.72 |
| 50 | 77.99 | 0.18 | 20.43 | 1.24 | 0.09 | 1.5 |
| 51 | 77.99 | 0.18 | 20.43 | 1.24 | 0.09 | 2.2 |
| C52 | 78.6 | 0.3 | 19.7 | 1.2 | 0.2 | 0 |
| 53 | 78.6 | 0.3 | 19.7 | 1.2 | 0.2 | 0.8 |
| 54 | 78.6 | 0.3 | 19.7 | 1.2 | 0.2 | 0.8 |
| 55 | 78.6 | 0.3 | 19.7 | 1.2 | 0.2 | 1.8 |
| C56* | 53-57 | — | — | 43-47 | trace | — |
| C57** | 53-55 | — | — | 29-31 | — | — |
| C58*** | 70-80 | — | 18-27 | — | — | — |

*Blanket commercially available from Unifrax I LLC (Niagara Falls, NY, USA) under the designation DURABLANKET S.
**Blanket commercially available from Unifrax I LLC (Niagara Falls, NY, USA) under the designation DURABLANKET 2600; includes 15-17 weight percent ZrO₂.
***Blanket commercially available from Unifrax I LLC (Niagara Falls, NY, USA) under the designation ISOFRAX Blanket.

TABLE IV

| | | | | | Compression Recovery | | | |
|---|---|---|---|---|---|---|---|---|
| | Shrinkage (% of original) | | | | (% of original) | | | |
| | 1260 C. | 1260 C. | 1400 C. | 1500 C. | 1260 C. | 1260 C. | 1400 C. | 1500 C. |
| Sample | 24 hrs | 168 hrs | 24 hrs | 24 hrs | 24 hrs | 168 hrs | 24 hrs | 24 hrs |
| 38 | 8.093 | 11.198 | — | 23.580 | 15.073 | 6.431 | 1.723 | — |
| 39 | 3.652 | 5.247 | — | 22.120 | 12.770 | 6.299 | 1.569 | — |
| 40 | — | — | 11.340 | — | — | — | — | — |
| 41 | — | — | 3.460 | — | — | — | — | — |
| 42 | — | — | 5.530 | — | — | — | — | — |
| C43 | 39.4 | 43 | — | — | — | — | — | — |
| C44 | 10.9 | 17.7 | — | — | 14.4 | — | — | — |
| C45 | 14.6 | 20.5 | — | — | 1.4 | — | — | — |
| 46 | 11.8 | 31.1 | — | — | 29.6 | — | — | — |
| 47 | 16.3 | 29.8 | — | — | 11 | — | — | — |
| 48 | 14.3 | 25 | — | — | 12.9 | — | — | — |
| 49 | 2.3 | 2.7 | — | — | 17.9 | — | 9.9 | — |
| 50 | 1.5 | 2.3 | — | — | 21.5 | — | 12.9 | — |
| 51 | 0.8 | 5 | — | — | 25.5 | — | 14.2 | — |
| C52 | — | 8.63 | — | — | — | — | 4.8 | — |
| 53 | — | 2.77 | — | — | — | — | 15.8 | — |
| 54 | — | 1.98 | — | — | — | — | 11.3 | — |
| 55 | — | 1.87 | — | — | — | — | 16.4 | — |
| C56 | 4.5 | 11.5 | 11.7 | — | 24.2 | 16.9 | — | 0 |
| C57 | — | — | 3.6 | — | — | — | — | — |
| C58 | 5.7 | 9.1 | 11.4 | 13.3 | 9.5 | 1.8 | — | 375 |

As is shown in Tables III and IV above, magnesium silicate fiber samples which were coated with a phosphorous containing compound, measured as P₂O₅ generally exhibited excellent shrinkage values. Compression recovery and dissolution rate remained satisfactory.

The inorganic fiber of all embodiments may further include that the phosphorous containing compound as a component of the fiberization product, a coating on at least a portion of the exterior surface of the fiber, or combinations thereof.

The inorganic fiber of all embodiments may further include that the phosphorous containing compound component of the fiberization product or the phosphorous containing compound coating may comprise a phosphorous pentoxide bearing material. The fiberization product and/or coating may comprise greater than 0 to about 10 weight percent of a phosphorous pentoxide bearing material, measured as P₂O₅, based on the total weight of the fiber. The fiberization product and/or coating may comprise greater than 0 to about 5 weight percent, measured as P₂O₅, based on the total weight of the fiber. The fiberization product and/or coating may comprise greater than 0 to about 1.5 weight percent of a phosphorous pentoxide bearing material, measured as P₂O₅, based on the total weight of the fiber. The phosphorous containing compound may comprise at least one of ammonium phosphate or magnesium phosphate. The phosphorous containing compound may comprise magnesium phosphate.

The inorganic fiber of all embodiments may further include that the coating may comprise a solution of a phosphorous containing compound. The solution of a phosphorous containing compound may be derived from a precursor compound of phosphoric acid, a salt of phosphoric acid, or mixtures thereof. The phosphoric acid may be selected from the group consisting of metaphosphoric acid, orthophosphoric acid, polyphosphoric acid, superphosphoric acid, and mixtures thereof. The salt of phosphoric acid may be selected from the group consisting of alkali metal phosphates, alkaline earth metal phosphates, ammonium phosphates, and mixtures thereof. The salt of phosphoric acid may be selected from the group consisting of ammonium phosphate, magnesium phosphate and mixtures thereof. The salt of phosphoric acid may comprise magnesium phosphate. The salt of phosphoric acid may comprise diammonium phosphate.

The inorganic fiber of all embodiments may further include that the fiber exhibits a linear shrinkage of less than 3.5 percent or less when exposed to 1260° C. for 24 hours; a linear shrinkage of less than 5.0 percent or less when exposed to 1400° C. for 24 hours; and/or a linear shrinkage of less than 2.5 percent or less when exposed to 1400° C. for 24 hours.

The inorganic fiber of all embodiments may further include that the fiber has a solidification temperature of from about 1730° C. to less than 1780° C.

It will be understood that the embodiment(s) described herein is/are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments may be combined to provide the desired result.

We claim:

1. An inorganic fiber comprising the fiberization product of about 65 to about 86 weight percent silica, about 14 to about 35 weight percent magnesia, and (i) a phosphorous containing compound which is a component of the fiberization product, or (ii) as a coating on at least a portion of the exterior surface of the fiber, or (iii) as both a component of the fiberization product and as a coating.

2. The fiber of claim 1, wherein the phosphorous containing compound component of the fiberization product and/or the phosphorous containing compound coating comprises a phosphorous pentoxide bearing material.

3. The fiber of claim 2, wherein the fiberization product and/or coating comprises greater than 0 to about 10 weight percent of a phosphorous pentoxide bearing material, measured as P₂O₅, based on the total weight of the fiber.

4. The fiber of claim 3, wherein the fiberization product and/or coating comprises greater than 0 to about 5 weight percent of a phosphorous pentoxide bearing material, measured as P₂O₅, based on the total weight of the fiber.

5. The fiber of claim 4, wherein the fiberization product and/or coating comprises greater than 0 to about 1.5 weight percent of a phosphorous pentoxide bearing material, measured as P₂O₅, based on the total weight of the fiber.

6. The fiber of claim 2, wherein said phosphorous containing compound comprises at least one of ammonium phosphate or magnesium phosphate.

7. The fiber of claim 6, wherein said phosphorous containing compound comprises magnesium phosphate.

8. The fiber of claim 1, wherein the coating comprises a solution of a phosphorous containing compound.

9. The fiber of claim 8, wherein said phosphorous containing compound is derived from a precursor compound of phosphoric acid, a salt of phosphoric acid, or mixtures thereof.

10. The fiber of claim 9, wherein said phosphoric acid is selected from the group consisting of metaphosphoric acid, orthophosphoric acid, polyphosphoric acid, superphosphoric acid, and mixtures thereof.

11. The fiber of claim 9, wherein the salt of phosphoric acid is selected from the group consisting of alkali metal phosphates, alkaline earth metal phosphates, ammonium phosphates, and mixtures thereof.

12. The fiber of claim 11, wherein the salt of phosphoric acid is selected from the group consisting of ammonium phosphate, magnesium phosphate and mixtures thereof.

13. The fiber of claim 12, wherein the salt of phosphoric acid comprises magnesium phosphate.

14. The fiber of claim 12, wherein the salt of phosphoric acid comprises diammonium phosphate.

15. The fiber of claim 1, wherein the fiber exhibits a linear shrinkage of less than 3.5 percent or less when exposed to 1260° C. for 24 hours.

16. The fiber of claim 1, wherein the fiber exhibits a linear shrinkage of less than 5.0 percent or less when exposed to 1400° C. for 24 hours.

17. The fiber of claim 1, wherein the fiber exhibits a linear shrinkage of less than 2.5 percent or less when exposed to 1400° C. for 24 hours.

18. The fiber of claim 1, wherein the fiber has a solidification temperature of from about 1730° C. to less than 1780° C.

19. A method for preparing an inorganic fiber comprising:
forming a melt with ingredients comprising about 65 to about 86 weight percent silica, about 14 to about 35 weight percent magnesia, and a phosphorous containing compound;
producing fibers from the melt; and
optionally coating at least a portion of the surface of the resulting fibers at the point of fiberization or after fiberization with a phosphorous containing compound.

20. The method of claim 19, wherein the melt and/or coating comprises greater than 0 to about 10 weight percent of a phosphorous pentoxide bearing material, measured as P₂O₅, based on the total weight of the fiber.

21. The method of claim 20, wherein the melt and/or coating comprises greater than 0 to about 5 weight percent of a phosphorous pentoxide bearing material, measured as P₂O₅, based on the total weight of the fiber.

22. The method of claim 21, wherein the melt and/or coating comprises greater than 0 to about 1.5 weight percent of a phosphorous pentoxide bearing material, measured as P₂O₅, based on the total weight of the fiber.

23. The method of claim 19, wherein the coating comprises a solution of a phosphorous containing compound.

24. The method of claim 23, wherein greater than 0 to about 10 weight percent of a coating, measured as P₂O₅, is applied to the surface of the fibers.

25. The method of claim 23, from about 5 to about 10 weight percent of a coating, measured as P₂O₅, is applied to the surface of the fibers.

26. The method of claim 23, wherein the phosphorous containing compound is derived from a precursor compound of phosphoric acid, a salt of phosphoric acid, or mixtures thereof.

27. The method of claim 26, wherein the phosphoric acid is in the form of metaphosphoric acid, orthophosphoric acid, polyphosphoric acid, superphosphoric acid, or mixtures thereof.

28. The method of claim 26, wherein the salt of phosphoric acid is at least one of alkali metal phosphates, alkaline earth metal phosphates, ammonium phosphates, or mixtures thereof.

29. The method of claim 26, wherein the salt of phosphoric acid is at least one of ammonium phosphate or magnesium phosphate.

30. The method of claim 29, wherein the salt of phosphoric acid is magnesium phosphate.

31. The method of claim 29, wherein the salt of phosphoric acid is diammonium phosphate.

32. The method of claim 19, wherein the step of producing fibers from the melt occurs at a solidification temperature of from about 1730° C. to less than 1780° C.

33. The method of claim 19, wherein the fiber exhibits a linear shrinkage of less than 3.5 percent or less when exposed to 1260° C. for 24 hours.

34. The method of claim 19, wherein the fiber exhibits a linear shrinkage of less than 5 percent or less when exposed to 1400° C. for 24 hours.

35. A method for preparing an inorganic fiber comprising:
forming a melt with ingredients comprising from about 65 to about 86 weight percent silica and about 14 to about 35 weight percent magnesia;
producing fibers from the melt; and
coating at least a portion of the surfaces of the resulting fibers at the point of fiberization or after fiberization with a phosphorous containing compound.

36. The method of claim 35, wherein the coating comprises a solution of a phosphorous containing compound.

37. The method of claim 36, wherein greater than 0 to about 10 weight percent of a coating, measured as P₂O₅ is applied to the surface of the fibers.

38. The method of claim 36, from about 5 to about 10 weight percent of a coating, measured as P₂O₅, is applied to the surface of the fibers.

39. The method of claim 36, wherein the coating of the phosphorous containing compound is derived from a precursor compound of phosphoric acid, a salt of phosphoric acid, or mixtures thereof.

40. The method of claim 39, wherein the phosphoric acid is in the form of metaphosphoric acid, orthophosphoric acid, polyphosphoric acid, superphosphoric acid, or mixtures thereof.

41. The method of claim 39, wherein the salt of phosphoric acid is at least one of alkali metal phosphates, alkaline earth metal phosphates, ammonium phosphates, or mixtures thereof.

42. The method of claim 41, wherein the salt of phosphoric acid is at least one of ammonium phosphate or magnesium phosphate.

43. The method of claim 42, wherein the salt of phosphoric acid is magnesium phosphate.

44. The method of claim 42, wherein the salt of phosphoric acid is diammonium phosphate.

45. The method of claim 35, wherein the step of producing fibers from the melt occurs at a solidification temperature of from about 1730° C. to less than 1780° C.

46. The method of claim 35, wherein the fiber exhibits a linear shrinkage of less than 3.5 percent or less when exposed to 1260° C. for 24 hours.

47. The method of claim 35, wherein the fiber exhibits a linear shrinkage of less than 5 percent or less when exposed to 1400° C. for 24 hours.

48. A method of insulating an article, including disposing on, in, near or around the article, a thermal insulation material, said insulation material comprising the fiberization product of a melt of ingredients comprising from about 65 to about 86 weight percent silica and from about 14 to about 35 weight percent magnesia, wherein the inorganic fiber further comprises a phosphorous containing compound incorporated throughout the fiber, or as a coating on at least a portion of said fiber, or both.

49. An inorganic fiber containing article comprising at least one of bulk fiber, blankets, needled blankets, papers, felts, cast shapes, vacuum cast forms, or compositions, said fiber containing article comprising the fiberization product of claim 1.
